(19) United States
(12) Patent Application Publication
(10) Pub. No.: US 2024/0373467 A1
(43) Pub. Date: Nov. 7, 2024

(54) COMMUNICATION METHOD AND DEVICE

(71) Applicant: GUANGDONG OPPO MOBILE TELECOMMUNICATIONS CORP., LTD., Dongguan (CN)

(72) Inventors: Pei ZHOU, Dongguan (CN); Lei HUANG, Singapore (SG)

(21) Appl. No.: 18/773,895

(22) Filed: Jul. 16, 2024

Related U.S. Application Data
(63) Continuation of application No. PCT/CN2022/073264, filed on Jan. 21, 2022.

(51) Int. Cl. H04W 74/0816; H04W 28/02

(52) U.S. Cl. CPC H04W 74/0816; H04W 28/0268; H04W 28/0278

(57) ABSTRACT

This application provides a communication method and a device. The communication method includes: controlling, by a first device, frame transmission within a shared TXOP time based on a transmission opportunity (TXOP) sharing mode and/or a channel detection result. In embodiments of this application, a shared TXOP time can be effectively utilized.

### CROSS-REFERENCE TO RELATED APPLICATIONS

This application is a continuation of International Application No. PCT/CN2022/073264, filed on Jan. 21, 2022, the disclosure of which is hereby incorporated by reference in its entirety.

### TECHNICAL FIELD

This application relates to the field of communications, and more specifically, to a communication method and a device.

### BACKGROUND

In wireless communications, a triggered transmission opportunity mechanism allows an AP to share a portion of its obtained transmission opportunity (TXOP) with a STA. How to better share a TXOP is an issue that needs to be considered.

### SUMMARY

Embodiments of this application provide a communication method and a device, so that a shared TXOP time can be effectively utilized.

An embodiment of this application provides a communication method, including: controlling, by a first device, frame transmission within a shared TXOP time based on a TXOP sharing mode and/or a channel detection result.

An embodiment of this application provides a communication method, including: controlling, by a second device, frame transmission within a shared TXOP time based on a TXOP sharing mode.

An embodiment of this application provides a communication method, including: receiving and/or sending, by a communication device, a peer report frame, where the peer report frame is used to report information of a third device that is on a peer end and that is about to perform P2P communication with a second device.

An embodiment of this application provides a communication method, including: sending and/or receiving, by a communication device, a first frame, where the first frame includes a shared TXOP time and/or a TXOP sharing mode.

An embodiment of this application provides a first device, including: a processing unit, configured to control frame transmission within a shared TXOP time based on a TXOP sharing mode and/or a channel detection result.

An embodiment of this application provides a second device, including: a processing unit, configured to control frame transmission within a shared TXOP time based on a TXOP sharing mode.

An embodiment of this application provides a communication device, including: a communication unit, configured to receive and/or send a peer report frame, where the peer report frame is used to report information of a third device that is on a peer end and that is about to perform P2P communication with a second device.

An embodiment of this application provides a communication device, including: a communication unit, configured to send and/or receive a first frame, where the first frame includes a shared TXOP time and/or a TXOP sharing mode.

An embodiment of this application provides a communication device, including: a processor and a memory. The memory is configured to store a computer program, and the processor is configured to invoke and run the computer program stored in the memory to cause the communication device to perform the method according to any embodiment of this application.

An embodiment of this application further provides a chip, configured to implement the method described above. Specifically, the chip includes a processor, configured to invoke and run a computer program from a memory to cause a device installed with the chip to perform the method according to any embodiment of this application.

An embodiment of this application provides a computer-readable storage medium, configured to store a computer program. When the computer program is run by a device, the device is enabled to perform the method according to any embodiment of this application.

An embodiment of this application provides a computer program product, including computer program instructions, and the computer program instructions cause a computer to perform the method according to any embodiment of this application.

An embodiment of this application provides a computer program. When the computer program is run on a computer, the computer is enabled to perform the method according to any embodiment of this application.

According to embodiments of this application, frame transmission is controlled within a shared TXOP time based on a TXOP sharing mode and/or a channel detection result, so that a shared TXOP time can be effectively utilized.

### BRIEF DESCRIPTION OF DRAWINGS

FIG. 1 is schematic diagram of an application scenario according to an embodiment of this application.

FIG. 2 is a schematic diagram of a triggered TXOP sharing mode 1.

FIG. 3 is a schematic diagram of a triggered TXOP sharing mode 2.

FIG. 4 is a schematic diagram of sharing different RUs to two pairs of devices for use in a triggered TXOP mechanism.

FIG. 5 is a schematic flowchart of a communication method 500 according to an embodiment of this application.

FIG. 6 is a schematic flowchart of a communication method 600 according to an embodiment of this application.

FIG. 7 is a schematic flowchart of a communication method 700 according to an embodiment of this application.

FIG. 8 is a schematic flowchart of a communication method 800 according to an embodiment of this application.

FIG. 9 is a schematic block diagram of a first device 900 according to an embodiment of this application.

FIG. 10 is a schematic block diagram of a second device 1000 according to an embodiment of this application.

FIG. 11 is a schematic block diagram of a communication device 1100 according to an embodiment of this application.

FIG. 12 is a schematic block diagram of a communication device 1200 according to an embodiment of this application.

FIG. 13 is a schematic diagram of communication between an AP and a STA before triggered TXOP sharing.

FIG. 14 is a schematic diagram of a structure of a MAC frame.

FIG. 15 is a schematic diagram of first performing uplink transmission and then performing P2P transmission in a TXOP sharing mode 2.

FIG. 16 is a schematic diagram of first performing P2P transmission and then performing uplink transmission in a TXOP sharing mode 2.

FIG. 17 is a schematic diagram of bidirectional communication between an AP and a STA.

FIG. 18 is a schematic diagram of resending an MU-RTS TXS TF after an AP learns of a peer STA of a STA.

FIG. 19 is a schematic diagram of proactively informing an AP of a peer STA of a STA by the STA in time division mode.

FIG. 20 is a schematic diagram of inquiring a peer STA of a STA by an AP in time division mode.

FIG. 21 is a schematic diagram of using different RUs for sending by an AP and a STA in a TXOP sharing mode 1.

FIG. 22 is a schematic diagram of using different RUs for sending by an AP and a STA, and the STA and a peer STA in a TXOP sharing mode 2.

FIG. 23 is a schematic diagram of proactively informing an AP of a peer STA of a STA by the STA in frequency division.

FIG. 24 is a schematic diagram of inquiring a peer STA of a STA by an AP in frequency division.

FIG. 25 is a schematic diagram of a structure of a peer report frame.

FIG. 26 is a schematic diagram of a format of an MU-RTS TXS TF.

FIG. 27 is a schematic diagram of a format of a peer STA collection frame.

FIG. 28 is a schematic block diagram of a communication device according to an embodiment of this application.

FIG. 29 is a schematic block diagram of a chip according to an embodiment of this application.

FIG. 30 is a schematic block diagram of a communication system according to an embodiment of this application.

### DESCRIPTION OF EMBODIMENTS

The following describes the technical solutions in embodiments of this application in combination with the accompanying drawings in embodiments of this application.

The technical solutions in embodiments of this application may be applied to various communications systems, for example, a wireless local area network (WLAN), wireless fidelity (WiFi), or another communication system.

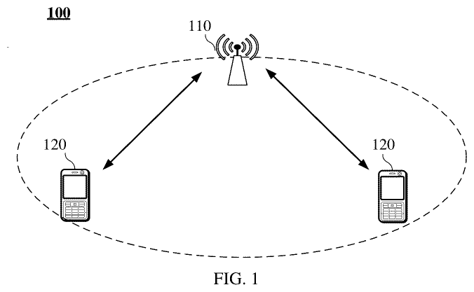

For example, a communication system 100 to which an embodiment of this application is applied is shown in FIG. 1. The communication system 100 may include an access point (AP) 110 and stations (STA) 120 that access a network through the access point 110.

In some scenarios, an AP is referred to as an AP STA. That is, in a sense, the AP is also a STA.

In some scenarios, a STA is referred to as a non-AP STA.

Communication in the communication system 100 may be communication between an AP and a non-AP STA, or may be communication between a non-AP STA and a non-AP STA, or communication between a STA and a peer STA, where the peer STA may refer to a device that performs peer-to-peer communication with the STA, for example, the peer STA may be an AP, or may be a non-AP STA.

An AP is equivalent to a bridge that connects a wired network and a wireless network. A major function of the AP is to connect clients in a wireless network together and then connects the wireless network to an Ethernet. An AP device may be a terminal device (for example, a mobile phone) or a network device (for example, a router). The terminal device or the network device has a chip for implementing a communication function, such as a WLAN or WiFi chip.

It should be understood that a role of a STA in a communication system is not fixed. For example, in some scenarios, when a mobile phone is connected to a router, the mobile phone is a non-AP STA; when the mobile phone serves as a hotspot of another mobile phone, the mobile phone serves as an AP.

The AP and the non-AP STA may be devices applied in vehicle-to-everything; internet of things nodes, sensors, and the like in internet of things (IoT); intelligent cameras, intelligent remote controls, intelligent water meters, intelligent electricity meters, and the like in smart home; and sensors and the like in smart city.

In some embodiments, the non-AP STA may support an 802.11be standard. The non-AP STA may also support a plurality of current and future wireless local area network (WLAN) standards of an 802.11 family, such as 802.11ax, 802.11ac, 802.11n, 802.11g, 802.11b, and 802.11a.

In some embodiments, the AP may be a device that supports the 802.11be standard. The AP may alternatively be a device that supports a plurality of current and future WLAN standards of the 802.11 family, such as 802.11ax, 802.11ac, 802.11n, 802.11g, 802.11b, and 802.11a.

In embodiments of this application, the STA may be a device that supports a WLAN/WiFi technology, such as a mobile phone, a pad, a computer, a virtual reality (VR) device, an augmented reality (AR) device, a wireless device in industrial control, a set-top box, a wireless device in self-driving, a vehicle-mounted communication device, a wireless device in remote medical, a wireless device in smart grid, a wireless device in transportation safety, a wireless device in smart city, a wireless device in smart home, a wireless communication chip, an ASIC, a SoC, or the like.

Frequency bands supported by a WLAN technology may include but are not limited to a low frequency band (such as 2.4 GHz, 5 GHz, or 6 GHz) and a high frequency band (for example, 60 GHz).

FIG. 1 exemplarily shows one AP STA and two non-AP STAs. Optionally, the communication system 100 may include a plurality of AP STAs and another quantity of non-AP STAs. This is not limited in embodiments of this application.

It should be understood that the terms “system” and “network” may often be used interchangeably herein. In this specification, the term “and/or” is merely an association relationship that describes associated objects, and represents that there may be three relationships. For example, A and/or B may represent three cases: only A exists, both A and B exist, and only B exists. In addition, the character “/” in the specification generally indicates an “or” relationship between the associated objects.

It should be understood that, the “indication” mentioned in embodiments of this application may be a direct indication or an indirect indication, or indicate an association. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In description of embodiments of this application, the term “corresponding” may mean that there is a direct or indirect correspondence between the two, or may mean that there is an association relationship between the two, or may mean that there is a relationship such as indicating and being indicated, or configuring and being configured.

For ease of understanding of the technical solutions in embodiments of this application, the following describes technologies related to embodiments of this application. The following related technologies, as optional solutions, may be randomly combined with the technical solutions of embodiments of this application, all of which fall within the protection scope of embodiments of this application.

A triggered transmission opportunity sharing (Triggered TXOP sharing) mechanism introduced in 802.11be allows an AP to share a portion of its obtained transmission opportunity (TXOP) with a STA. This mechanism includes two modes: In mode 1, uplink transmission can be performed, and a STA can unidirectionally transmit a non-trigger based (non-TB) PPDU (physical layer protocol data unit) to its associated AP. In mode 2, uplink transmission and P2P (Peer to Peer) transmission can be performed, and the STA unidirectionally transmits a non-TB PPDU to its associated AP or another peer STA.

### 1. Triggered Transmission Opportunity Sharing Procedure

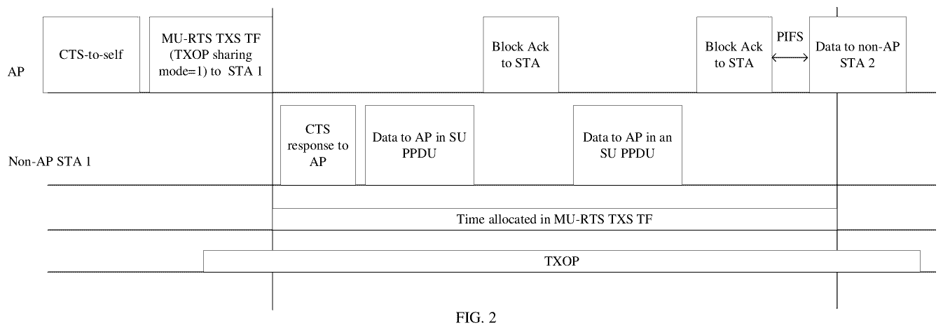

In a triggered transmission opportunity sharing procedure mode 1, an AP shares its obtained TXOP with a STA (for example, STA 1 in FIG. 2), and allows STA 1 only to send an uplink non-TB PPDU to the AP. The AP responds only to a frame that requires immediate acknowledgment, such as an acknowledgment (Ack) frame/block acknowledgment (BlockAck) frame, and does not respond to a data frame.

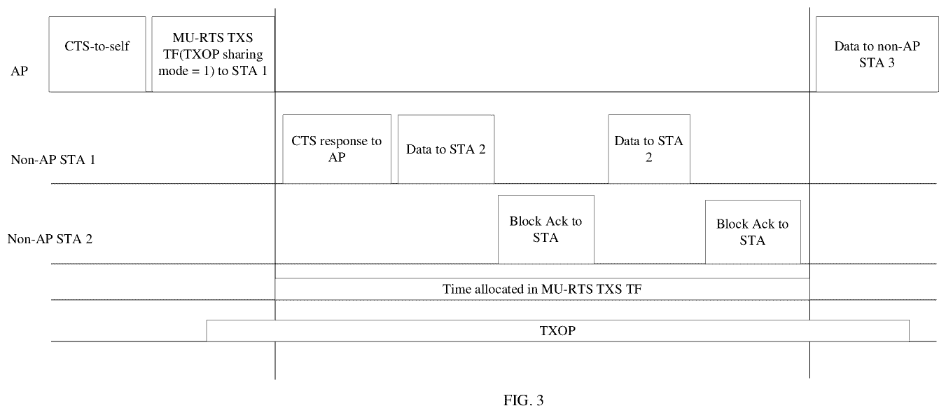

In a triggered transmission opportunity sharing procedure mode 2, an AP shares its obtained TXOP with a STA (for example, STA 1 in FIG. 3), and allow STA 1 only to send an uplink non-TB PPDU to the AP; or to send a non-TB PPDU to another peer STA (for example, STA 2 in FIG. 3). The AP and the peer STA respond only to a frame that requires immediate acknowledgment, such as an Ack frame/BlockAck frame, and does not respond to a data frame.

### 2. Rules for AP to Reuse Allocated Time

As shown in FIG. 2, if an AP sends an MU-RTS (multi-user request to send) TXS (transmission opportunity sharing) TF (Trigger frame) carrying a transmission opportunity sharing mode field (TXOP Sharing Mode subfield)=1 to a STA and then receives a CTS frame returned by the STA, the AP is not allowed to send any PPDU within a time shared with the STA and indicated in the MU-RTS TXS TF, except in the following cases:
the STA sends a PPDU that requires an immediate response; or
within a PIFS (priority interframe space) time after the AP sends an immediate response frame to the STA or the AP receives a frame that is sent by the STA and that does not require an immediate response, a carrier sense mechanism (CS mechanism) detects that a channel medium is idle.

As shown in FIG. 3, if an AP sends an MU-RTS TXS TF carrying a TXOP Sharing Mode subfield=2 to a STA and then receives a CTS frame returned by the STA, the AP is not allowed to send any PPDU within a time shared with the STA and indicated in the MU-RTS TXS TF, except in the following case:
the STA sends a PPDU that requires an immediate response.

### 3. Sharing Different RUs to a Plurality of STAs for Use in Triggered Transmission Opportunity Sharing (Triggered TXOP Sharing) Mechanism

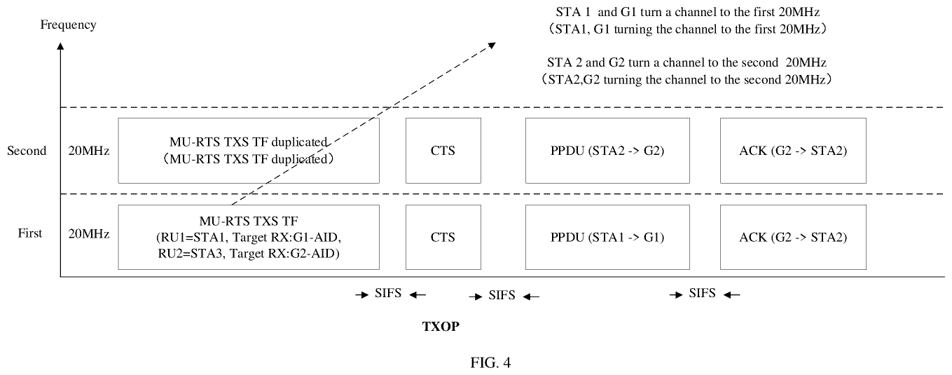

An AP is allowed to share a portion of its obtained TXOP time, for sending a non-TB PPDU, with a plurality of non-AP stations (non-AP STAs). As shown in FIG. 4, within a shared time, an AP allocates resource unit (RU) 1 to STA 1, where RU 1 is used by STA 1 to send a non-TB PPDU to G1; and allocates RU 2 to STA 2, where RU 2 is used by STA 2 to send a non-TB PPDU to G2.

This solution proposes allocation of different RUs to a plurality of STAs to send non-TB PPDUs. Referring to FIG. 4, in the triggered TXOP sharing mechanism, different RUs can be shared between two pairs of devices (that is, STA 1 and G1, and STA 2 and G2) for use.

Based on points 1 and 2, it may be learned that how the AP selects TXOP sharing mode 1 or mode 2 is not provided.

Based on points 1 and 2, it may be learned that after the STA sends a non-TB PPDU to the AP, the AP is not allowed to send, to the STA, PPDUs except a PPDU that requires an immediate response; and after the STA sends a non-TB PPDU to a peer STA, the peer STA is not allowed to send, to the STA, PPDUs except a PPDU that requires an immediate response.

Based on point 3, it may be learned that, in the TXOP sharing mode 2, even if the STA has sent all frames that the STA wants to send within a time period shared by the AP, the AP is not allowed to send other frames in a remaining time of the time period shared by the AP, resulting in a waste of the TXOP time.

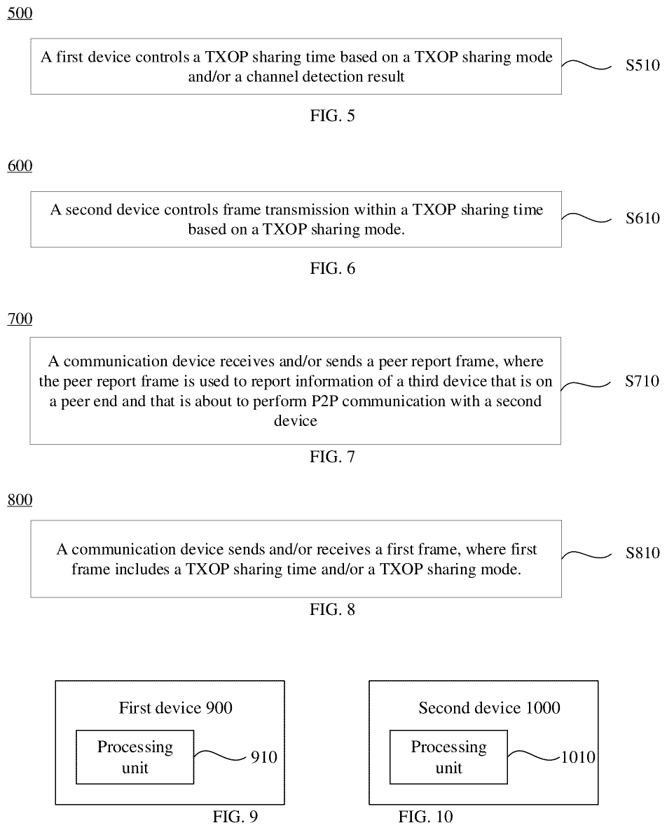

FIG. 5 is a schematic flowchart of a communication method 500 according to an embodiment of this application. Optionally, the method may be applied to the system shown in FIG. 1, but is not limited thereto. The method includes at least a part of the following content:

S510: A first device controls frame transmission within a shared TXOP time based on a TXOP (transmission opportunity) sharing mode and/or a channel detection result.

In this embodiment of the present disclosure, the first device may be an AP, and a second device may be a STA. The TXOP sharing mode may include a TXOP sharing mode 1 and a TXOP sharing mode 2. The channel detection result may include that a channel is idle, or a channel is busy, or the like. The shared TXOP time may include a portion of time of a TXOP that is shared by the AP with a target STA. The AP may control, based on the TXOP sharing mode and the channel detection result, whether to transmit a frame within a shared TXOP time. For example, the AP may transmit a data frame, a control frame, a management frame, or the like to the target STA or another STA.

In an implementation, the method further includes: performing, by the first device, channel detection to obtain the channel detection result.

In an implementation, the performing, by the first device, channel detection includes: in a case that the TXOP sharing mode is a TXOP sharing mode 2 and a CTS (clear to send) frame returned by the second device is received, performing at least one of following:
using a carrier sensing mechanism to detect a channel medium within a PIFS (priority interframe space) time after the first device completes sending an immediate response frame to the second device; or
using a carrier sensing mechanism to detect a channel medium within a PIFS time after the first device receives a frame that is sent by the second device and that does not require an immediate response.

For example, the carrier sensing mechanism detects a channel medium within a PIFS time after the AP completes sending an immediate response frame to the STA. For another example, the carrier sensing mechanism detects a channel medium within a PIFS time after the AP receives a frame that is sent by the STA and that does not require an immediate response.

In an implementation, the channel detection result includes that the channel medium is idle or the channel medium is busy.

In an implementation, the controlling, by a first device, frame transmission within a shared TXOP time based on a TXOP sharing mode and/or a channel detection result includes: in the case of the TXOP sharing mode 2 and in a case that the channel medium is idle, sending, by the first device, a PPDU at a first moment after the PIFS. For example, in the case of the TXOP sharing mode 2, within a PIFS time after the AP completes sending an immediate response frame to the STA or receives a frame that is sent by the STA and that does not require an immediate response, the carrier sensing mechanism detects that the channel medium is idle. In this case, the AP may send a PPDU to the STA at a specific moment after the PIFS.

In an implementation, the first moment is after the second device completes sending all frames and before the shared TXOP time ends within the shared TXOP time.

In an implementation, the first moment is a moment at which the PIFS ends. For example, after the STA completes sending all frames within a time (for example, time T2) shared by the AP, if the AP detects that the channel medium is idle within a PIFS time (from time T2 to time T3) within the shared TXOP time, the AP can send other frames at the end of PIFS (for example, time T3). In addition, the AP may send other frames within a PIFS time after the AP completes sending an immediate response frame to the STA or receives a frame that is sent by the STA and that does not require an immediate response and in a case that the carrier sensing mechanism detects that the channel medium is idle. Therefore, the AP does not need to wait until the shared TXOP time (for example, time T4) to send other frames.

In an implementation, the second device is used to perform P2P transmission first and then uplink transmission in a case that the TXOP sharing mode is the TXOP sharing mode 2 and there are uplink transmission and P2P transmission, where the uplink transmission is uplink transmission from the second device to the first device, and the P2P transmission is P2P transmission from the second device to a peer third device.

In this embodiment of the present disclosure, a transmission order of the second device may be controlled by using an instruction of the first device or by modifying or predefining a rule on the second device. In this way, in the case of the TXOP sharing mode 2, if the second device has both uplink transmission to the first device and P2P transmission to the third device, the second device may perform P2P transmission first and then uplink transmission. Because the P2P transmission is performed before the uplink transmission, and the first device detects that the channel medium within a PIFS time is idle within the shared TXOP time, namely, a time shared with the second device, the first device can send other frames after the PIFS. In addition, the first device, for example, the AP may send other frames within a PIFS time after the first device completes sending an immediate response frame to the second device, for example, the STA or receives a frame that is sent by the second device and that does not require an immediate response in a case that the carrier sensing mechanism detects that the channel medium is idle. Therefore, the first device does not need to wait until the shared TXOP time to send other frames, which can save a remaining time of the shared TXOP time and improve utilization of time domain resources.

In an implementation, the method further includes: sending, by the first device, a BSRP (buffer status report poll) trigger frame to the second device.

In an implementation, the method further includes: receiving, by the first device, a QoS (quality of service) data frame from the second device.

In an implementation, the QoS data frame is a QoS null frame.

In an implementation, a type value of a frame control field of the QoS data frame is set to 2, and a subtype value is set to 12, indicating that the QoS data frame is a QoS null frame.

In an implementation, the type value of the frame control field is set to 2, and B3B2 of the frame control field is 10; and the subtype value of the frame control field is set to 12, and B7B6B5B4 of the frame control field is 1100. For example, in a MAC (medium access control) frame structure, a frame control field includes 2 bytes (Octets), with a total of 16 bits, some of which are used to indicate a type value, and some of which are used to indicate a subtype value. In the frame control field, two bits B3 and B2 are used to indicate the type value, B3=1 and B2=0, that is, B3B2=10, which can indicate that the type value of the frame control field is 2. In the frame control field, four bits B7, B6, B5 and B4 are used to indicate the subtype value, B7=B6=1 and B5=B4=0, that is, B7B6B5B4=1100, which can indicate that the subtype value of the frame control field is 12. In this case, the QoS data frame is a QoS null frame.

In an implementation, the QoS null frame includes a QoS control field and an HT (high throughput) control (HT Control) field.

In an implementation, the QoS control field of the QoS null frame includes at least one of the following:
a first subfield, used to indicate that information indicated by the QoS control field is used for a transmission type of the second device; or
a second subfield, used to indicate a length of time that the second device requests the first device to share.

For example, the QoS control field of the QoS null frame includes 2 bytes (Octets), with a total of 16 bits, some of which are used to indicate the first subfield, and some of which are used to indicate the second subfield.

In an implementation, a value of the first subfield represents at least one of following:
that the information indicated by the QoS control field is used for uplink transmission from the second device to the first device; or
that the information indicated by the QoS control field is used for P2P transmission from the second device to the third device.

In an implementation, in a case that a triggered TXOP sharing support field (Triggered TXOP Sharing Support field) in an EHT (extremely high throughput) capabilities element of each of the first device and the second device is 1, a field of the QoS null frame sent by the second device and received by the first device is used to indicate at least one of the following:
B4 or B7 of the QoS control field is set to a first value, and B8 to B15 of the QoS control field represent a TXOP duration requested for UL transmission only (TXOP Duration Requested for UL Transmission Only); or
B4 or B7 of the QoS control field is set to a second value, and B8 to B15 of the QoS control field represent a TXOP Duration Requested at least for P2P Transmission.

In this embodiment of this application, B4 and/or B7 of the QoS control field of the QoS null frame may be a first subfield of the QoS control field, and B8 to B15 of the QoS control field may be a second subfield of the QoS control field.

In an implementation, the first value is 0, and the second value is 1. Alternatively, the first value is 1, and the second value is 0.

For example, B4 or B7 of the QoS control field of the QoS null frame is set to 0, which indicates that information indicated by B8 to B15 of the QoS control field is for only TXOP duration request for the STA to perform uplink transmission. B4 or B7 of the QoS control field of the QoS null frame is set to a 1, which indicates that information indicated by B8 to B15 of the QoS control field is for at least a TXOP duration request for the STA to perform P2P transmission.

For another example, B4 or B7 of the QoS control field of the QoS null frame is set to 1, which indicates that information indicated by B8 to B15 of the QoS control field is for only a TXOP duration request for the STA to perform uplink transmission. B4 or B7 of the QoS control field of the QoS null frame is set to a 0, which indicates that information indicated by B8 to B15 of the QoS control field is for at least a TXOP duration request used for the STA to perform P2P transmission.

In an implementation, B8 to B15 of the QoS control field indicate a length of time that the second device requests to be shared by the first device.

In an implementation, the eight bits B8 to B15 of the QoS control field indicate a value range of 0 to 255, an indicated time length is in units of 32 μs (microseconds), and the time length requested by the second device and indicated by B8 to B15 of the QoS control field ranges from 32 μs to 8160 μs.

In an implementation, a value 0 indicated by B8 to B15 of the QoS control field indicates that the second device does not request the first device to allocate time.

In an implementation, the method further includes: sending, by the first device, a first frame, where the first frame includes the TXOP sharing mode and/or the shared TXOP time.

In an implementation, the TXOP sharing mode and/or the shared TXOP time are/is determined by the first device based on a QoS null frame or a peer report frame from the second device. In the embodiment of the present disclosure, after receiving the QoS empty frame or the peer report frame from the second device, the first device may determine the TXOP sharing mode and/or the shared TXOP time based on the QoS null frame or the peer report frame. Then, the first device may generate a first frame including the TXOP sharing mode and/or the shared TXOP time, and then send the first frame to the second device.

In an implementation, the TXOP sharing mode and/or the shared TXOP time are/is directly determined by the first device. In this embodiment of the present disclosure, the first device may directly determine the TXOP sharing mode and/or the shared TXOP time. Then, when performing uplink transmission to the first device or performing P2P transmission to the third device, the second device operates according to an indication of the first frame of the first device.

In an implementation, the first frame includes a TXOP sharing mode field, used to indicate the TXOP sharing mode.

In an implementation, a value of the TXOP sharing mode field is used to represent at least one of the following:
the TXOP sharing mode 1; or
the TXOP sharing mode 2.

In an implementation, the value of the TXOP sharing mode field is determined based on a first subfield and/or a second subfield in a QoS control field of a QoS null frame or a peer report frame.

In an implementation, the value of the TXOP sharing mode field is determined directly by the first device. The first device may directly determine the value of the TXOP sharing mode field.

In an implementation, a manner of determining the value of the TXOP sharing mode field includes at least one of the following:
in a case that B4 or B7 of the QoS control field is set to the second value and B8 to B15 of the QoS control field are 0, the TXOP sharing mode field being 1; or
in a case that B4 or B7 of the QoS control field is set to the second value and B8 to B15 of the QoS control field are not 0, the TXOP sharing mode field being 2.

In this embodiment of the present disclosure, the TXOP sharing mode field is 1, which indicates that a current TXOP sharing mode is the TXOP sharing mode 1; or the TXOP sharing mode field is 2, which indicates that a current TXOP sharing mode is the TXOP sharing mode 2.

In an implementation, the first frame includes a shared TXOP time (TXOP) field, used to indicate the shared TXOP time.

In an implementation, the first frame is a multi-user request to send (MU-RTS) transmission opportunity sharing (TXS) trigger frame (TF).

In an implementation, bidirectional communication is allowed within the shared TXOP time. The bidirectional communication can be in time division mode or frequency division mode. They are described below separately.

In an implementation, in time division mode, the bidirectional communication includes: uplink communication and downlink communication between the first device and the second device at different moments within the shared TXOP time in a case that the TXOP sharing mode is the TXOP sharing mode 1.

In an implementation, in time division mode, the bidirectional communication includes at least one of the following:
uplink communication and downlink communication between the first device and the second device at different moments within the shared TXOP time in a case that the TXOP sharing mode is the TXOP sharing mode 2; or

P2P communication between the second device and the third device at different moments
within the shared TXOP time in a case that the TXOP sharing mode is the TXOP sharing mode 2.

In an implementation, the uplink communication and downlink communication between the first device and the second device at different moments within the shared TXOP time includes at least one of the following:
that the first device and the second device alternately send PPDUs within the shared TXOP time; or
that the first device and the second device contend for sending PPDUs in a random backoff DCF (distributed coordination function) manner within the shared TXOP time.

In this embodiment of the present disclosure, by alternately sending or contending for sending PPDUs, the first device and the second device can be prevented from sending frames simultaneously within the shared TXOP time, for example, between time T3 and time T4 in the foregoing example, to avoid a conflict.

In an implementation, that the first device and the second device alternately send PPDUs within the shared TXOP time includes:
the first device receives a first PPDU sent by the second device;
the first device sends first acknowledgment information when SIFS elapses since the reception of the first PPDU sent by the second device;
the first device sends a second PPDU when SIFS elapses since the sending the first acknowledgment information;
the first device receives second acknowledgment information sent by the second device; and
when SIFS elapses since the second device sends the second acknowledgment information, the step in which the first device receives a first PPDU sent by the second device is repeated until the first device and the second device have no PPDU to be sent or the shared TXOP time ends.

In an implementation, the acknowledgment information is an Ack frame or a BlockAck frame. For example, the first acknowledgment information sent by the first device may be an Ack frame or a BlockAck frame. For another example, the second acknowledgment information sent by the second device may be an Ack frame or a BlockAck frame.

For example, the AP sends a first Ack frame or a first BlockAck frame when a SIFS time after the reception of a first PPDU of the STA, and the AP sends a next second PPDU when a SIFS time elapses since the sending the first Ack frame or the first BlockAck frame. Then the STA returns a second Ack frame or a second BlockAck frame. After the SIFS time of the second Ack frame or the second BlockAck frame, the STA continues to send the first PPDU, and so on, until the AP and/or STA have/has no frames to send, or a time allocated by the AP ends.

In an implementation, for a specific process of the P2P communication between the second device and the third device at different moments within the shared TXOP time, reference may be made to related description of a communication method embodiment performed by the second device.

In an implementation, in frequency division mode, the bidirectional communication includes: uplink communication and downlink communication between the first device and the second device on different RUs within the shared TXOP time in a case that the TXOP sharing mode is the TXOP sharing mode 1.

In an implementation, in frequency division mode, the bidirectional communication includes at least one of the following:
uplink communication and downlink communication between the first device and the second device on different RUs within the shared TXOP time in a case that the TXOP sharing mode is the TXOP sharing mode 2; or
P2P communication between the second device and the third device on different RUs within the shared TXOP time in a case that the TXOP sharing mode is the TXOP sharing mode 2.

In an implementation, the uplink communication and downlink communication between the first device and the second device on different RUs within the shared TXOP time includes:
the first device sends a first PPDU on a first RU to the second device; and
the first device receives, on a second RU, a second PPDU returned by the second device.

In an implementation, for a specific process of the P2P communication between the second device and the third device on different RUs within the shared TXOP time, reference may be made to related description of a communication method embodiment performed by the second device.

In an implementation, the method further includes:
obtaining, by the first device, information of a third device, where the third device is a peer device with which the second device performs P2P communication; and
sending, by the first device, a first frame to the second device and the third device, where the first frame includes the shared TXOP time and/or the TXOP sharing mode.

In this embodiment of the present disclosure, the AP may not only send the first frame to a target STA with which the AP shares the TXOP, but may also send the first frame to another STA, such as STA 2, that is about to perform P2P communication with the target STA.

In an implementation, the first frame is an MU-RTS TF.

In an implementation, a common information field of the first frame is used to indicate that the first frame is an MU-RTS TF (trigger frame).

In an implementation, a value of a trigger type subfield in the common information field is set to 3, indicating that the first frame is an MU-RTS TF. For example, in a trigger frame, when a value of the Trigger Type subfield in the Common Info field is set to 3, the trigger frame is an MU-RTS TF.

In an implementation, a TXOP sharing mode field of the MU-RTS TF reuses 2 bits of the common information field. In this case, the TXOP sharing mode field may be considered as a subfield in the common information field, and therefore the TXOP sharing mode field may be referred to as a TXOP sharing mode subfield.

In an implementation, the TXOP sharing mode field reuses B20 and B21 of the common information field.

In an implementation, in a case that the TXOP sharing mode field of the MU-RTS TF has a non-zero value, the MU-RTS TF is an MU-RTS TXS TF.

In an implementation, in a case that a value of the TXOP sharing mode field is 1, 2, or 3, the MU-RTS TF is an MU-RTS TXS TF.

In an implementation, a user information list field of the first frame includes at least one of the following:
that an AID12 subfield in a first user information field is used to indicate 12 least significant bits of an AID of the second device; or
that an AID12 subfield in a second user information field is used to indicate 12 least significant bits of an AID of a third device.

For example, AID12 subfields of two user information fields in the user information list (User Info List) field of the MU-RTS TXS TF are used to respectively indicate 12 least significant bits of an AID of the STA and 12 least significant bits of an AID of the peer STA of the STA. The AID12 subfield of the user information field is equal to 12 LSBs (least significant bit) of an AID of a STA.

In an implementation, the user information list field of the first frame includes at least one of the following:
that an allocation duration subfield in a third user information field is used to indicate first duration (time duration) allocated by the first device to the second device; or
that a value of an allocation duration subfield in a fourth user information field is the first duration, which indicates that the third device and the second device share the same duration.

In an implementation, the common information field of the first frame includes an uplink length subfield (UL Length subfield); and the uplink length subfield includes an allocation duration subfield, and the allocation duration subfield is used to indicate first duration allocated by the first device to the second device and/or the third device.

For example, B4 to B15 of the Common Information field, with a total of 12 bits, may be redefined as an allocation duration subfield, used to indicate duration (time duration) allocated to the STA and its peer STA.

In an implementation, a user information field of the first frame includes an RU allocation subfield, used to indicate an RU used by the second device and/or an RU used by the third device. For example, RU allocation subfields of two user information fields in the user information list field are used to respectively indicate an RU used by the STA and an RU used by the peer STA of the STA.

In an implementation, in time division mode, the RU used by the second device and/or the RU used by the third device indicated in the RU allocation subfield are identical. For example, in time division mode, a same RU may be used for transmission at different times. Therefore, the RU used by the second device and/or the RU used by the third device indicated in two RU allocation subfields may be identical. Alternatively, in time division mode, the RU used by the second device and/or the RU used by the third device indicated in two RU allocation subfields may be different.

In an implementation, in frequency division mode, the RU used by the second device and/or the RU used by the third device indicated in the RU allocation subfield are different. For example, in frequency division mode, different RUs may be used for transmission at a same time. Therefore, the RU used by the second device and/or the RU used by the third device indicated in two RU allocation subfields are different.

In an implementation, the method further includes: receiving, by the first device, a peer report frame from the second device, where the peer report frame is used to report information of the third device that is on a peer end and that is about to perform P2P communication with the second device. For example, the STA sends a peer report frame to the AP, and after receiving the peer report frame, the STA may obtain information of the peer STA of the STA from the peer report frame.

In an implementation, the peer report frame includes: a PA (peer STA MAC address) field, where the PA field is used to indicate a MAC address of the third device on the peer end of the second device.

In an implementation, in a case that the peer report frame is proactively reported by the second device, the PA field exists in the peer report frame. For example, a PA field exists in a peer report frame proactively sent by the STA to the AP.

In an implementation, in a case that the peer report frame is a response of the second device after the first device sends a peer device collection frame, the peer report frame includes at least one of the following:
that in a case that the PA field exists in the peer report frame, the second device has a need for P2P transmission in the TXOP sharing mode 2; or
that in a case that no PA field exists in the peer report frame, the second device has no need for P2P transmission in the TXOP sharing mode 2.

In an implementation, the method further includes: sending, by the first device, a peer device collection frame to the second device.

For example, after the AP sends a peer device collection frame, for example, a peer STA collection frame to the STA, the STA returns a peer report frame to the AP as a response. If the PA field exists in the peer report frame returned by the STA, it may indicate that the STA has a need for P2P transmission. If no PA field exists in the peer report frame returned by the STA, it may indicate that the STA has no need for P2P transmission.

In this embodiment of the present disclosure, the peer device collection frame may be a control frame. For example, a frame type of a frame is set to 1, indicating that the frame is a control frame, a value of a subtype of a frame is set to 6, indicating that the frame is an extended control frame, and a value of a control frame extension is set to 14 (which may be any value from 12 to 15), indicating that the frame is a control frame of a Peer STA Collect frame.

In an implementation, the peer device collection frame may include a peer device collection field. The peer device collection field is used to inquire whether the second device has a need for P2P transmission and/or inquire about information of a third device that is on a peer end of the second device. For example, the peer device collection field is a peer STA collection field. Peer STA Collect field=1 indicates that the AP inquires whether the STA has a need for P2P transmission and inquires information of the peer STA. Peer STA Collect field=0 indicates that the AP does not inquire whether the STA has a need for P2P transmission or inquire information of the peer STA.

In an implementation, the method further includes: after sending a first frame to the second device, receiving, by the first device, a CTS returned by the second device; and the receiving, by the first device, a peer report frame includes: receiving, by the first device when SIFS elapses since the reception of the CTS frame, the peer report frame sent by the second device.

For example, after the AP sends an MU-RTS TXS TF to the target STA, the target STA first returns a CTS frame and then proactively informs, through a new peer report frame after the SIFS time, the AP of a peer STA with which the target STA needs to exchange data. Then the AP sends an MU-RTS TXS TF to share this period of time again with the target STA and the peer STA of the target STA.

In an implementation, the peer report frame includes a QoS control field. For information carried in the QoS control field, reference can be made to the information carried in the QoS control field of the QoS null frame.

In an implementation, the QoS control field of the peer report frame includes at least one of the following:
a first subfield, used to indicate that information indicated by the QoS control field is used for a transmission type of the second device; or
a second subfield, used to indicate a length of time that the second device requests the first device to share.

In an implementation, a value of the first subfield represents at least one of following:
that the information indicated by the QoS control field is used for uplink transmission from the second device to the first device; or
that the information indicated by the QoS control field is used for P2P transmission from the second device to the third device.

In an implementation, in a case that a triggered TXOP sharing support field in an EHT capabilities element of each of the first device and the second device is 1, a field of the peer report frame sent by the second device and received by the first device is used to indicate at least one of following:
that B4 or B7 of the QoS control field is set to a first value, and B8 to B15 of the QoS control field represent a TXOP duration request used for only uplink transmission; or
that B4 or B7 of the QoS control field is set to a second value, and B8 to B15 of the QoS control field represent a TXOP duration request for at least P2P transmission.

In this embodiment of this application, B4 and/or B7 of the QoS control field of the peer report frame may be a first subfield of the QoS control field, and B8 to B15 of the QoS control field may be a second subfield of the QoS control field.

In this embodiment of this application, B4 and/or B7 of the QoS control field may be a first subfield of the QoS control field, and B8 to B15 of the QoS control field may be a second subfield of the QoS control field.

In an implementation, the first value is 0, and the second value is 1; or the first value is 1, and the second value is 0.

In an implementation, B8 to B15 of the QoS control field indicate a length of time that the second device requests to be shared by the first device.

In an implementation, the eight bits B8 to B15 of the QoS control field indicate a value range of 0 to 255, an indicated time length is in units of 32 μs, and the time length requested by the second device and indicated by B8 to B15 of the QoS control field ranges from 32 μs to 8160 μs.

In an implementation, a value 0 indicated by B8 to B15 of the QoS control field indicates that the second device does not request the first device to allocate time.

FIG. 6 is a schematic flowchart of a communication method 600 according to an embodiment of this application. Optionally, the method may be applied to the system shown in FIG. 1, but is not limited thereto. The communication method includes at least a part of the following content:

S610: A second device controls frame transmission within a shared TXOP time based on a TXOP sharing mode.

In this embodiment of the present disclosure, the first device may be an AP, and a second device may be a STA. The TXOP sharing mode may include a TXOP sharing mode 1 and a TXOP sharing mode 2. The channel detection result may include that a channel is idle, or a channel is busy, or the like. The shared TXOP time may include a portion of time of a TXOP that is shared by the AP with a target STA. The STA may control, based on the TXOP sharing mode, whether to transmit a frame within the shared TXOP time. For example, the STA may transmit a data frame, a control frame, a management frame, or the like to the AP or another STA.

In an implementation, that a second device controls frame transmission within a shared TXOP time based on a TXOP sharing mode includes at least one of the following:
performing, by the second device, P2P transmission first and then uplink transmission in a case that the TXOP sharing mode is a TXOP sharing mode 2 and there are uplink transmission and P2P transmission;
performing, by the second device, only uplink transmission in a case that the TXOP sharing mode is a TXOP sharing mode 2 and there is only uplink transmission; or
performing, by the second device, only P2P transmission in a case that the TXOP sharing mode is a TXOP sharing mode 2 and there is only P2P transmission.

The uplink transmission is uplink transmission from the second device to the first device, and the P2P transmission is P2P transmission from the second device to a peer third device.

In this embodiment of the present disclosure, a transmission order may be controlled according to an instruction of the first device or by modifying or predefining a rule on the second device. In this way, in the case of the TXOP sharing mode 2, if the second device has both uplink transmission to the first device and P2P transmission to the third device, P2P transmission may be performed first and then uplink transmission is performed. Because the P2P transmission is performed before the uplink transmission, and the first device detects that the channel medium within a PIFS time is idle within the shared TXOP time, namely, a time shared with the second device, the first device can send other frames after the PIFS. In addition, the first device such as the AP may send other frames within a PIFS time after the first device completes sending an immediate response frame to the second device, for example, the STA or receives a frame that is sent by the second device and that does not require an immediate response in a case that the carrier sensing mechanism detects that the channel medium is idle.

Therefore, the first device does not need to wait until the shared TXOP time to send other frames, which can save a remaining time of the shared TXOP time and improve utilization of time domain resources.

In an implementation, the method further includes: receiving, by the second device, a BSRP trigger frame from the first device.

In an implementation, the method further includes: sending, by the second device, a QoS data frame to the first device.

In an implementation, the QoS data frame is a QoS null frame.

In an implementation, a type value of a frame control field of the QoS data frame is set to 2, and a subtype value is set to 12, indicating that the QoS data frame is a QoS null frame.

In an implementation, the type value of the frame control field is set to 2, and B3B2 of the frame control field is 10; and the subtype value of the frame control field is set to 12, and B7B6B5B4 of the frame control field is 1100.

In an implementation, the QoS null frame includes a QoS control field and/or an HT control field.

In an implementation, the QoS control field of the QoS null frame includes at least one of the following:
a first subfield, used to indicate that information indicated by the QoS control field is used for a transmission type of the second device; or
a second subfield, used to indicate a length of time that the second device requests the first device to share.

In an implementation, a value of the first subfield represents at least one of following:
the information indicated by the QoS control field is used for uplink transmission from the second device to the first device; or
the information indicated by the QoS control field is used for P2P transmission from the second device to the third device.

In an implementation, in a case that a triggered TXOP sharing support field in an EHT capabilities element of each of the first device and the second device is 1, a field of QoS null frame sent by the second device and received by the first device is used to indicate at least one of following:
that B4 or B7 of the QoS control field is set to a first value, and B8 to B15 of the QoS control field represent a TXOP duration request used for only uplink transmission; or
that B4 or B7 of the QoS control field is set to a second value, and B8 to B15 of the QoS control field represent a TXOP duration request for at least P2P transmission.

In an implementation, the first value is 0, and the second value is 1. Alternatively, the first value is 1, and the second value is 0.

In an implementation, B8 to B15 of the QoS control field indicate a length of time that the second device requests to be shared by the first device.

In an implementation, the eight bits B8 to B15 of the QoS control field indicate a value range of 0 to 255, an indicated time length is in units of 32 μs, and the time length requested by the second device and indicated by B8 to B15 of the QoS control field ranges from 32 μs to 8160 μs, where a value 0 indicated by B8 to B15 of the QoS control field indicates that the second device does not request the first device to allocate time.

In an implementation, the method further includes: receiving, by the second device, a first frame, where the first frame includes the TXOP sharing mode and/or the shared TXOP time.

In an implementation, the TXOP sharing mode and/or the shared TXOP time are/is determined by the first device based on a QoS null frame or a peer report frame from the second device.

In an implementation, the TXOP sharing mode and/or the shared TXOP time are/is directly determined by the first device.

In an implementation, the first frame includes a TXOP sharing mode field, used to indicate the TXOP sharing mode.

In an implementation, a value of the TXOP sharing mode field represents at least one of following:
a TXOP sharing mode 1; or
a TXOP sharing mode 2.

In an implementation, the value of the TXOP sharing mode field is determined based on a first subfield and/or a second subfield in a QoS control field of a QoS null frame or a peer report frame.

In an implementation, the value of the TXOP sharing mode field is determined directly by the first device. In this embodiment of the present disclosure, the first device may directly determine the value of the TXOP sharing mode field.

In an implementation, a manner of determining the value of the TXOP sharing mode field includes at least one of the following:
that in a case that B4 or B7 of the QoS control field is set to the second value and B8 to B15 of the QoS control field are 0, the TXOP sharing mode field is 1; or
that in a case that B4 or B7 of the QoS control field is set to the second value and B8 to B15 of the QoS control field are not 0, the TXOP sharing mode field is 2.

In an implementation, the first frame includes a shared TXOP time field, used to indicate the shared TXOP time.

In an implementation, the first frame is an MU-RTS TXS TF.

In an implementation, bidirectional communication is allowed within the shared TXOP time.

In an implementation, in time division mode, the bidirectional communication includes: uplink communication and downlink communication between the first device and the second device at different moments within the shared TXOP time in a case that the TXOP sharing mode is the TXOP sharing mode 1.

In an implementation, in time division mode, the bidirectional communication includes at least one of the following:
uplink communication and downlink communication between the first device and the second device at different moments within the shared TXOP time in a case that the TXOP sharing mode is the TXOP sharing mode 2; or
P2P communication between the second device and the third device at different moments within the shared TXOP time in a case that the TXOP sharing mode is the TXOP sharing mode 2.

In an implementation, the uplink communication and downlink communication between the first device and the second device at different moments within the shared TXOP time includes at least one of the following:
that the first device and the second device alternately send PPDUs within the shared TXOP time; or
that the first device and the second device contend for sending PPDUs in a random backoff DCF manner within the shared TXOP time.

In an implementation, that the first device and the second device alternately send PPDUs within the shared TXOP time includes:
that the second device sends a first PPDU to the first device;
that the second device receives first acknowledgment information that is sent by the first device when SIFS elapses since the reception of the first PPDU;
that the second device receives a second PPDU that is sent by the first device when SIFS elapses since the sending the first acknowledgment information;
that the second device sends second acknowledgment information to the first device; and
when SIFS elapses since the second device sends the second acknowledgment information, the step in which the second device sends a first PPDU to the first device is repeated until the first device and the second device have no PPDU to be sent or the shared TXOP time ends.

In an implementation, the P2P communication between the second device and the third device at different moments within the shared TXOP time includes at least one of the following:
that the second device and the third device alternately send PPDUs within the shared TXOP time; or
that the second device and the third device contend for sending PPDUs in a random backoff DCF manner within the shared TXOP time.

In an implementation, that the second device and the third device alternately send PPDUs within the shared TXOP time includes:
that the second device sends a third PPDU to the third device;
that the second device receives third acknowledgment information that is sent by the third device when SIFS elapses since the reception of the third PPDU;
that the second device receives a fourth PPDU that is sent by the third device when SIFS elapses since the sending the third acknowledgment information;
that the second device sends fourth acknowledgment information to the third device; and when SIFS elapses since the second device sends the fourth acknowledgment information, the step in which the second device sends a third PPDU to the third device is repeated until the second device and the third device have no PPDU to be sent or the shared TXOP time ends.

In an implementation, the acknowledgment information is an acknowledgment Ack frame or a block acknowledgment BlockAck frame. For example, the first acknowledgment information sent by the first device to the second device may be an Ack frame or a BlockAck frame. For another example, the second acknowledgment information sent by the second device to the first device may be an Ack frame or a BlockAck frame. For another example, the third acknowledgment information sent by the third device to the second device may be an Ack frame or a BlockAck frame. For another example, the fourth acknowledgment information sent by the second device to the third device may be an Ack frame or a BlockAck frame.

For example, the third device G1 sends the third Ack frame or the third BlockAck frame when the SIFS time elapsed since reception of the third PPDU of the second device STA 1. When the SIFS time elapsed since the sending the third Ack frame or the third BlockAck frame, G1 sends a next fourth PPDU, and then STA 1 returns a fourth Ack frame or a fourth BlockAck frame. When SIFS time elapsed since returning the fourth Ack frame or the fourth BlockAck frame, STA 1 continues to send a PPDU, and so on, until STA 1 and/or G1 have/has no frames to send, or a time allocated by the AP ends.

In an implementation, in frequency division mode, the bidirectional communication includes: uplink communication and downlink communication between the first device and the second device on different RUs within the shared TXOP time in a case that the TXOP sharing mode is the TXOP sharing mode 1.

In an implementation, in frequency division mode, the bidirectional communication includes at least one of the following:
uplink communication and downlink communication between the first device and the second device on different RUs within the shared TXOP time in a case that the TXOP sharing mode is the TXOP sharing mode 2; or
P2P communication between the second device and the third device on different RUs within the shared TXOP time in a case that the TXOP sharing mode is the TXOP sharing mode 2.

In an implementation, the uplink communication and downlink communication between the first device and the second device on different RUs within the shared TXOP time includes:
receiving, by the second device, a first PPDU that is sent by the first device on a first RU; and
returning, by the second device, a second PPDU on a second RU to the first device.

In an implementation, the P2P communication between the second device and the third device on different RUs within the shared TXOP time includes:
receiving, by the second device, a third PPDU that is sent by the third device on a third RU; and
returning, by the second device, a fourth PPDU on a fourth RU to the third device.

In an implementation, the method further includes:
sending, by the second device, information of a third device, where the third device is a peer device with which the second device performs P2P communication.

In an implementation, the first frame is an MU-RTS TF.

In an implementation, a common information field of the first frame is used to indicate that the first frame is an MU-RTS TF.

In an implementation, a value of a trigger type subfield in the common information field is set to 3, indicating that the first frame is an MU-RTS TF.

In an implementation, a TXOP sharing mode field of the MU-RTS TF reuses 2 bits of the common information field.

In an implementation, the TXOP sharing mode field reuses B20 and B21 of the common information field.

In an implementation, in a case that the TXOP sharing mode field of the MU-RTS TF has a non-zero value, the MU-RTS TF is an MU-RTS TXS TF.

In an implementation, in a case that a value of the TXOP sharing mode field is 1, 2, or 3, the MU-RTS TF is an MU-RTS TXS TF.

In an implementation, a user information list field of the first frame includes at least one of the following:
that an AID12 subfield in a first user information field is used to indicate 12 least significant bits of an AID of the second device; or
that an AID12 subfield in a second user information field is used to indicate 12 least significant bits of an AID of a third device.

In an implementation, a user information list field of the first frame includes at least one of the following:
that an allocation duration subfield in a third user information field is used to indicate first duration allocated by the first device to the second device; or
that a value of an allocation duration subfield in a fourth user information field is the first duration, which indicates that the third device and the second device share same duration.

In an implementation, the common information field of the first frame includes an uplink length subfield.

The uplink length subfield includes an allocation duration subfield, and the allocation duration subfield is used to indicate first duration allocated by the first device to the second device and/or the third device.

In an implementation, a user information field of the first frame includes:
an RU allocation subfield, used to indicate an RU used by the second device and/or an RU used by the third device.

In an implementation, in time division mode, the RU used by the second device and/or the RU used by the third device indicated in the RU allocation subfield are identical.

In an implementation, in frequency division mode, the RU used by the second device and/or the RU used by the third device indicated in the RU allocation subfield are different.

In an implementation, the method further includes: receiving, by the second device, a peer device collection frame from the first device.

In an implementation, the peer device collection frame may include a peer device collection field. The peer device collection field is used to inquire whether the second device has a need for P2P transmission and/or inquire about information of a third device that is on a peer end of the second device.

In an implementation, the method further includes: sending, by the second device, a peer report frame to a first device, where the peer report frame is used to report information of a third device that is on the peer end and that is about to perform P2P communication with the second device.

In an implementation, the peer report frame includes: a PA field, where the PA field is used to indicate a MAC address of the third device on the peer end of the second device.

In an implementation, in a case that the peer report frame is proactively reported by the second device, the PA field exists in the peer report frame.

In an implementation, in a case that the peer report frame is a response of the second device after the first device sends a peer device collection frame, the peer report frame includes at least one of the following:
that in a case that the PA field exists in the peer report frame, the second device has a need for P2P transmission in the TXOP sharing mode 2; or
that in a case that no PA field exists in the peer report frame, the second device has no need for P2P transmission in the TXOP sharing mode 2.

In an implementation, the method further includes: returning, by the second device, a CTS frame to the first device after receiving the first frame of the first device; and the sending, by the second device, a peer report frame to the first device includes: sending, by the second device, the peer report frame to the first device when SIFS elapses since the reception of the CTS.

In an implementation, the peer report frame includes a QoS control field. For information carried in the QoS control field, reference can be to the information carried in the QoS control field of the QoS null frame.

In an implementation, the QoS control field of the peer report frame includes at least one of the following:
a first subfield, used to indicate that information indicated by the QoS control field is used for a transmission type of the second device; or
a second subfield, used to indicate a length of time that the second device requests the first device to share.

In an implementation, a value of the first subfield represents at least one of following:
the information indicated by the QoS control field is used for uplink transmission from the second device to the first device; or
the information indicated by the QoS control field is used for P2P transmission from the second device to the third device.

In an implementation, in a case that a triggered TXOP sharing support field in an EHT capabilities element of each of the first device and the second device is 1, a QoS control field of the peer report frame sent by the second device and received by the first device is used to indicate at least one of following:
that B4 or B7 of the QoS control field is set to a first value, and B8 to B15 of the QoS control field represent a TXOP duration request used for only uplink transmission; or
that B4 or B7 of the QoS control field is set to a second value, and B8 to B15 of the QoS control field represent a TXOP duration request for at least P2P transmission.

In this embodiment of this application, B4 and/or B7 of the QoS control field of the peer report frame may be a first subfield of the QoS control field, and B8 to B15 of the QoS control field may be a second subfield of the QoS control field.

In this embodiment of this application, B4 and/or B7 of the QoS control field may be a first subfield of the QoS control field, and B8 to B15 of the QoS control field may be a second subfield of the QoS control field.

In an implementation, the first value is 0, and the second value is 1. Alternatively, the first value is 1, and the second value is 0.

In an implementation, B8 to B15 of the QoS control field indicate a length of time that the second device requests to be shared by the first device.

In an implementation, the eight bits B8 to B15 of the QoS control field indicate a value range of 0 to 255, an indicated time length is in units of 32 μs, and the time length requested by the second device and indicated by B8 to B15 of the QoS control field ranges from 32 μs to 8160 μs.

In an implementation, a value 0 indicated by B8 to B15 of the QoS control field indicates that the second device does not request the first device to allocate time.

For a specific example of the second device performing the method 600 in this embodiment, reference can be made to related description about the second device in the foregoing method 500. For brevity, details are not described herein again.

FIG. 7 is a schematic flowchart of a communication method 700 according to an embodiment of this application. Optionally, the method may be applied to the system shown in FIG. 1, but is not limited thereto. The communication method includes at least a part of the following content.

S710: A communication device receives and/or sends a peer report frame, where the peer report frame is used to report information of a third device that is on a peer end and that is about to perform P2P communication with a second device.

In an implementation, the communication device is a first device such as an AP. The first device may receive a peer report frame from the second device such as a STA.

In an implementation, the communication device is the second device such as a STA. The second device may send a peer report frame to the first device such as an AP.

In an implementation, the peer report frame includes: a PA field, where the PA field is used to indicate a MAC address of the third device on the peer end of the second device.

In an implementation, in a case that the peer report frame is proactively reported by the second device, the PA field exists in the peer report frame.

In an implementation, in a case that the peer report frame is a response of the second device after the first device sends a peer device collection frame, the peer report frame includes at least one of the following:
that in a case that the PA field exists in the peer report frame, the second device has a need for P2P transmission in the TXOP sharing mode 2; or
that in a case that no PA field exists in the peer report frame, the second device has no need for P2P transmission in the TXOP sharing mode 2.

In an implementation, the peer report frame includes a QoS control field. For information carried in the QoS control field, reference can be made to the information carried in the QoS control field of the QoS null frame.

In an implementation, the QoS control field of the peer report frame includes at least one of the following:
a first subfield, used to indicate that information indicated by the QoS control field is used for a transmission type of the second device; or
a second subfield, used to indicate a length of time that the second device requests the first device to share.

In an implementation, a value of the first subfield represents at least one of following:
the information indicated by the QoS control field is used for uplink transmission from the second device to the first device; or
the information indicated by the QoS control field is used for P2P transmission from the second device to the third device.

In an implementation, in a case that a triggered TXOP sharing support field in an EHT capabilities element of each of the first device and the second device is 1, a QoS control field of the peer report frame sent by the second device and received by the first device is used to indicate at least one of following:
that B4 or B7 of the QoS control field is set to a first value, and B8 to B15 of the QoS control field represent a TXOP duration request used for only uplink transmission; or
that B4 or B7 of the QoS control field is set to a second value, and B8 to B15 of the QoS control field represent a TXOP duration request for at least P2P transmission.

In this embodiment of this application, B4 and/or B7 of the QoS control field of the peer report frame may be a first subfield of the QoS control field, and B8 to B15 of the QoS control field may be a second subfield of the QoS control field.

In this embodiment of this application, B4 and/or B7 of the QoS control field may be a first subfield of the QoS control field, and B8 to B15 of the QoS control field may be a second subfield of the QoS control field.

In an implementation, the first value is 0, and the second value is 1. Alternatively, the first value is 1, and the second value is 0.

In an implementation, B8 to B15 of the QoS control field indicate a length of time that the second device requests to be shared by the first device.

In an implementation, the eight bits B8 to B15 of the QoS control field indicate a value range of 0 to 255, an indicated time length is in units of 32 μs, and the time length requested by the second device and indicated by B8 to B15 of the QoS control field ranges from 32 μs to 8160 μs.

In an implementation, a value 0 indicated by B8 to B15 of the QoS control field indicates that the second device does not request the first device to allocate time.

For a specific example of the communication device performing the method 700 in this embodiment and a specific example of the peer report frame, reference can be to related description in the foregoing methods 500 and 600. For brevity, details are not described herein again.

FIG. 8 is a schematic flowchart of a communication method 800 according to an embodiment of this application. Optionally, the method may be applied to the system shown in FIG. 1, but is not limited thereto. The communication method includes at least a part of the following content:

S810: A communication device sends and/or receives a first frame, where the first frame includes a shared TXOP time and/or a TXOP sharing mode.

In an implementation, the communication device is a first device such as an AP. The first device may send the first frame to a second device such as a STA.

In an implementation, the communication device is the second device, for example, a STA. The second device may receive the first frame from the first device, for example, an AP.

In an implementation, the TXOP sharing mode and/or the shared TXOP time are/is determined by the first device based on a QoS null frame or a peer report frame from the second device.

In an implementation, the TXOP sharing mode and/or the shared TXOP time are/is directly determined by the first device.

In an implementation, the first frame includes a TXOP sharing mode field, used to indicate the TXOP sharing mode.

In an implementation, a value of the TXOP sharing mode field represents at least one of following:
a TXOP sharing mode 1; or
a TXOP sharing mode 2.

In an implementation, the value of the TXOP sharing mode field is determined based on a first subfield and/or a second subfield in a QoS control field of a QoS null frame or a peer report frame.

In an implementation, a manner of determining the value of the TXOP sharing mode field includes at least one of the following:
that in a case that B4 or B7 of the QoS control field is set to the second value and B8 to B15 of the QoS control field are 0, the TXOP sharing mode field is 1; or
that in a case that B4 or B7 of the QoS control field is set to the second value and B8 to B15 of the QoS control field are not 0, the TXOP sharing mode field is 2.

In an implementation, the value of the TXOP sharing mode field is determined directly by the first device.

In an implementation, the first frame is an MU-RTS TF.

In an implementation, a common information field of the first frame is used to indicate that the first frame is an MU-RTS TF.

In an implementation, a value of a trigger type subfield in the common information field is set to 3, indicating that the first frame is an MU-RTS TF.

In an implementation, a TXOP sharing mode field of the MU-RTS TF reuses 2 bits of the common information field.

In an implementation, the TXOP sharing mode field reuses B20 and B21 of the common information field.

In an implementation, in a case that the TXOP sharing mode field has a non-zero value, the MU-RTS TF is an MU-RTS TXS TF.

In an implementation, in a case that a value of the TXOP sharing mode field is 1, 2, or 3, the MU-RTS TF is an MU-RTS TXS TF.

In an implementation, a user information list field of the first frame includes at least one of the following:
that an AID12 subfield in a first user information field is used to indicate 12 least significant bits of an AID of the second device; or
that an AID12 subfield in a second user information field is used to indicate 12 least significant bits of an AID of a third device.

In an implementation, a user information list field of the first frame includes at least one of the following:
that an allocation duration subfield in a third user information field is used to indicate first duration allocated by the first device to the second device; or
that a value of an allocation duration subfield in a fourth user information field is the first duration, which indicates that the third device and the second device share same duration.

In an implementation, the common information field of the first frame includes an uplink length subfield.

The uplink length subfield includes an allocation duration subfield, and the allocation duration subfield is used to indicate first duration allocated by the first device to the second device and/or the third device.

In an implementation, a user information field of the first frame includes:
an RU allocation subfield, used to indicate an RU used by the second device and/or an RU used by the third device.

In an implementation, in time division mode, the RU used by the second device and/or the RU used by the third device indicated in the RU allocation subfield are identical.

In an implementation, in frequency division mode, the RU used by the second device and/or the RU used by the third device indicated in the RU allocation subfield are different.

For a specific example of the communication device performing the method 800 in this embodiment and a specific example of the first frame, reference can be to foregoing related description in the foregoing methods 500 and 600. For brevity, details are not described herein again.

FIG. 9 is a schematic block diagram of a first device 900 according to an embodiment of this application. The first device 900 may include:
a processing unit 910, configured to control frame transmission within a shared TXOP time based on a TXOP sharing mode and/or a channel detection result.

In an implementation, the device further includes: a channel detection unit, configured to perform channel detection to obtain the channel detection result.

In an implementation, the channel detection unit is configured to: in a case that the TXOP sharing mode is a TXOP sharing mode 2 and a CTS frame returned by the second device is received, perform at least one of following:
using a carrier sensing mechanism to detect a channel medium within a priority interframe space PIFS time after sending an immediate response frame to the second device is completed; or
using a carrier sensing mechanism to detect a channel medium within a PIFS time after a frame that is sent by the second device and that does not require an immediate response is received.

In an implementation, the channel detection result includes that the channel medium is idle or the channel medium is busy.

In an implementation, the controlling, by a first device, frame transmission within a shared TXOP time based on a TXOP sharing mode and/or a channel detection result includes: in the case of the TXOP sharing mode 2 and in a case that the channel medium is idle, sending, by the first device, a PPDU at a first moment after the PIFS.

In an implementation, the first moment is after the second device completes sending all frames and before the shared TXOP time ends within the shared TXOP time.

In an implementation, the first moment is a moment at which the PIFS ends.

In an implementation, the second device is used to perform P2P transmission first and then uplink transmission in a case that the TXOP sharing mode is the TXOP sharing mode 2 and there are uplink transmission and P2P transmission, where the uplink transmission is uplink transmission from the second device to the first device, and the P2P transmission is P2P transmission from the second device to a peer third device.

In an implementation, the device further includes: a first sending unit, configured to send a BSRP trigger frame to the second device.

In an implementation, the device further includes: a first receiving unit, configured to receive a quality of service QoS data frame from the second device.

In an implementation, the QoS data frame is a QoS null frame.

In an implementation, a type value of a frame control field of the QoS data frame is set to 2, and a subtype value is set to 12, indicating that the QoS data frame is a QoS null frame.

In an implementation, the type value of the frame control field is set to 2, and B3B2 of the frame control field is 10; and the subtype value of the frame control field is set to 12, and B7B6B5B4 of the frame control field is 1100.

In an implementation, the QoS null frame includes a QoS control field and/or an HT control field.

In an implementation, the first device further includes: a second sending unit, configured to send a peer device collection frame to the second device.

In an implementation, the peer device collection frame may include a peer device collection field. The peer device collection field is used to inquire whether the second device has a need for P2P transmission and/or inquire about information of a third device that is on a peer end of the second device.

In an implementation, the first device further includes: a second receiving unit, configured to receive a peer report frame from the second device, where the peer report frame is used to report information of the third device that is on the peer end and that is about to perform P2P communication with the second device.

In an implementation, the peer report frame includes: a PA field, where the PA field is used to indicate a MAC address of the third device on the peer end of the second device.

In an implementation, in a case that the peer report frame is proactively reported by the second device, the PA field exists in the peer report frame.

In an implementation, in a case that the peer report frame is a response of the second device after the first device sends a peer device collection frame, the peer report frame includes at least one of the following:
that in a case that the PA field exists in the peer report frame, the second device has a need for P2P transmission in the TXOP sharing mode 2; or
that in a case that no PA field exists in the peer report frame, the second device has no need for P2P transmission in the TXOP sharing mode 2.

In an implementation, the first device further includes:
a third receiving unit, configured to: after the first frame is sent to the second device, receive a CTS frame returned by the second device.

The second receiving unit is further configured to: when SIFS elapses since the reception of the CTS frame, receive the peer report frame sent by the second device.

In an implementation, the peer report frame includes a QoS control field. For information carried in the QoS control field, reference can be to the information carried in the QoS control field of the QoS null frame.

In an implementation, the QoS control field of the QoS null frame or the peer report frame includes at least one of the following:
a first subfield, used to indicate that information indicated by the QoS control field is used for a transmission type of the second device; or
a second subfield, used to indicate a length of time that the second device requests the first device to share.

In an implementation, a value of the first subfield represents at least one of following:
that the information indicated by the QoS control field is used for uplink transmission from the second device to the first device; or
that the information indicated by the QoS control field is used for P2P transmission from the second device to the third device.

In an implementation, in a case that a triggered TXOP sharing support field in an EHT capabilities element of each of the first device and the second device is 1, a QoS control field of the QoS null frame or the peer report frame sent by the second device and received by the first device is used to indicate at least one of following:
that B4 or B7 of the QoS control field is set to a first value, and B8 to B15 of the QoS control field represent a TXOP duration request used for only uplink transmission; or
that B4 or B7 of the QoS control field is set to a second value, and B8 to B15 of the QoS control field represent a TXOP duration request for at least P2P transmission.

In an implementation, the first value is 0, and the second value is 1. Alternatively, the first value is 1, and the second value is 0.

In an implementation, B8 to B15 of the QoS control field indicate a length of time that the second device requests to be shared by the first device.

In an implementation, the eight bits B8 to B15 of the QoS control field indicate a value range of 0 to 255, an indicated time length is in units of 32 μs, and the time length requested by the second device and indicated by B8 to B15 of the QoS control field ranges from 32 μs to 8160 μs, where a value 0 indicated by B8 to B15 of the QoS control field indicates that the second device does not request the first device to allocate time.

In an implementation, the device further includes: a third sending unit, configured to send a first frame, where the first frame includes the TXOP sharing mode and/or the shared TXOP time.

In an implementation, the TXOP sharing mode and/or the shared TXOP time are/is determined by the first device based on a QoS null frame or a peer report frame from the second device.

In an implementation, the TXOP sharing mode and/or the shared TXOP time are/is directly determined by the first device.

In an implementation, the first frame includes a TXOP sharing mode field, used to indicate the TXOP sharing mode.

In an implementation, a value of the TXOP sharing mode field represents at least one of following:
a TXOP sharing mode 1; or
a TXOP sharing mode 2.

In an implementation, the value of the TXOP sharing mode field is determined based on a first subfield and/or a second subfield in a QoS control field of a QoS null frame or a peer report frame.

In an implementation, a manner of determining the value of the TXOP sharing mode field includes at least one of the following:
that in a case that B4 or B7 of the QoS control field is set to the second value and B8 to B15 of the QoS control field are 0, the TXOP sharing mode field is 1; or
that in a case that B4 or B7 of the QoS control field is set to the second value and B8 to B15 of the QoS control field are not 0, the TXOP sharing mode field is 2.

In an implementation, the value of the TXOP sharing mode field is determined directly by the first device.

In an implementation, the first frame includes a shared TXOP time field, used to indicate the shared TXOP time.

In an implementation, the first frame is a multi-user request to send MU-RTS transmission opportunity sharing TXS trigger frame TF.

In an implementation, bidirectional communication is allowed within the shared TXOP time.

In an implementation, in time division mode, the bidirectional communication includes: uplink communication and downlink communication between the first device and the second device at different moments within the shared TXOP time in a case that the TXOP sharing mode is the TXOP sharing mode 1.

In an implementation, in time division mode, the bidirectional communication includes at least one of the following:
uplink communication and downlink communication between the first device and the second device at different moments within the shared TXOP time in a case that the TXOP sharing mode is the TXOP sharing mode 2; or
P2P communication between the second device and the third device at different moments within the shared TXOP time in a case that the TXOP sharing mode is the TXOP sharing mode 2.

In an implementation, the uplink communication and downlink communication between the first device and the second device at different moments within the shared TXOP time includes at least one of the following:
that the first device and the second device alternately send PPDUs within the shared TXOP time; or
that the first device and the second device contend for sending PPDUs in a random backoff DCF manner within the shared TXOP time.

In an implementation, that the first device and the second device alternately send PPDUs within the shared TXOP time includes:
that the first device receives a first PPDU sent by the second device;
that the first device sends first acknowledgment information when SIFS elapses since the reception of the first PPDU sent by the second device;
that the first device sends a second PPDU when SIFS elapses since the sending the first acknowledgment information;
that the first device receives second acknowledgment information sent by the second device; and
when SIFS elapses since the second device sends the second acknowledgment information, the step in which the first device receives a first PPDU sent by the second device is repeated until the first device and the second device have no PPDU to be sent or the shared TXOP time ends.

In an implementation, the acknowledgment information is an acknowledgment Ack frame or a block acknowledgment BlockAck frame.

In an implementation, in frequency division mode, the bidirectional communication includes: uplink communication and downlink communication between the first device and the second device on different RUs within the shared TXOP time in a case that the TXOP sharing mode is the TXOP sharing mode 1.

In an implementation, in frequency division mode, the bidirectional communication includes at least one of the following:
uplink communication and downlink communication between the first device and the second device on different RUs within the shared TXOP time in a case that the TXOP sharing mode is the TXOP sharing mode 2; or
P2P communication between the second device and the third device on different RUs within the shared TXOP time in a case that the TXOP sharing mode is the TXOP sharing mode 2.

In an implementation, the uplink communication and downlink communication between the first device and the second device on different RUs within the shared TXOP time includes:
that the first device sends a first PPDU on a first RU to the second device; and
that the first device receives, on a second RU, a second PPDU returned by the second device.

In an implementation, the method further includes:
obtaining, by the first device, information of a third device, where the third device is a peer device with which the second device performs P2P communication; and
sending, by the first device, a first frame to the second device and the third device, where the first frame includes the shared TXOP time and/or the TXOP sharing mode.

In an implementation, the first frame is an MU-RTS TF.

In an implementation, a common information field of the first frame is used to indicate that the first frame is an MU-RTS TF.

In an implementation, a value of a trigger type subfield in the common information field is set to 3, indicating that the first frame is an MU-RTS TF.

In an implementation, a TXOP sharing mode field of the MU-RTS TF reuses 2 bits of the common information field.

In an implementation, the TXOP sharing mode field reuses B20 and B21 of the common information field.

In an implementation, in a case that the TXOP sharing mode field of the MU-RTS TF has a non-zero value, the MU-RTS TF is an MU-RTS TXS TF.

In an implementation, in a case that a value of the TXOP sharing mode field is 1, 2, or 3, the MU-RTS TF is an MU-RTS TXS TF.

In an implementation, a user information list field of the first frame includes at least one of the following:
that an AID12 subfield in a first user information field is used to indicate 12 least significant bits of an AID of the second device; or
that an AID12 subfield in a second user information field is used to indicate 12 least significant bits of an AID of a third device.

In an implementation, a user information list field of the first frame includes at least one of the following:
that an allocation duration subfield in a third user information field is used to indicate first duration allocated by the first device to the second device; or
that a value of an allocation duration subfield in a fourth user information field is the first duration, which indicates that the third device and the second device share same duration.

In an implementation, the common information field of the first frame includes an uplink length subfield.

The uplink length subfield includes an allocation duration subfield, and the allocation duration subfield is used to indicate first duration allocated by the first device to the second device and/or the third device.

In an implementation, a user information field of the first frame includes:
an RU allocation subfield, used to indicate an RU used by the second device and/or an RU used by the third device.

In an implementation, in time division mode, the RU used by the second device and/or the RU used by the third device indicated in the RU allocation subfield are identical.

In an implementation, in frequency division mode, the RU used by the second device and/or the RU used by the third device indicated in the RU allocation subfield are different.

The first device 900 in this embodiment of this application can implement a corresponding function of the first device in the embodiment of the foregoing method 500. For procedures, functions, implementations, and beneficial effects corresponding to modules (submodules, units, components or the like) in the first device 900, reference can be made to corresponding descriptions in the foregoing method embodiments. Details are not described herein again. It should be noted that functions of modules (submodules, units, components or the like) in the first device 900 in this embodiment of this application may be implemented by different modules (submodules, units, components or the like), or may be implemented by a same module (submodule, unit, component or the like).

FIG. 10 is a schematic block diagram of a second device 1000 according to an embodiment of this application. The second device 1000 may include:
a processing unit 1010, configured to control frame transmission within a shared TXOP time based on a TXOP sharing mode.

In an implementation, that the processing unit controls frame transmission within a shared TXOP time based on a TXOP sharing mode includes at least one of the following:
performing P2P transmission first and then uplink transmission in a case that the TXOP sharing mode is a TXOP sharing mode 2 and there are uplink transmission and P2P transmission;
performing only uplink transmission in a case that the TXOP sharing mode is a TXOP sharing mode 2 and there is only uplink transmission; or performing only P2P transmission in a case that the TXOP sharing mode is a
TXOP sharing mode 2 and there is only P2P transmission.

The uplink transmission is uplink transmission from the second device to a first device, and the P2P transmission is P2P transmission from the second device to a peer third device.

In an implementation, the second device further includes: a first receiving unit, configured to receive a BSRP trigger frame from the first device.

In an implementation, the second device further includes: a first sending unit, configured to send a QoS data frame to the first device.

In an implementation, the QoS data frame is a QoS null frame.

In an implementation, a type value of a frame control field of the QoS data frame is set to 2, and a subtype value is set to 12, indicating that the QoS data frame is a QoS null frame.

In an implementation, the type value of the frame control field is set to 2, and B3B2 of the frame control field is 10; and the subtype value of the frame control field is set to 12, and B7B6B5B4 of the frame control field is 1100.

In an implementation, the QoS null frame includes a QoS control field and/or an HT control field.

In an implementation, the second device further includes: a second receiving unit, configured to receive a peer device collection frame from the first device.

In an implementation, the peer device collection frame may include a peer device collection field. The peer device collection field is used to inquire whether the second device has a need for P2P transmission and/or inquire about information of a third device that is on a peer end of the second device.

In an implementation, the second device further includes: a second sending unit, configured to send a peer report frame to the first device, where the peer report frame is used to report information of the third device that is on the peer end and that is about to perform P2P communication with the second device.

In an implementation, the peer report frame includes: a PA field, where the PA field is used to indicate a MAC address of the third device on the peer end of the second device.

In an implementation, in a case that the peer report frame is proactively reported by the second device, the PA field exists in the peer report frame.

In an implementation, in a case that the peer report frame is a response of the second device after the first device sends a peer device collection frame, the peer report frame includes at least one of the following:
that in a case that the PA field exists in the peer report frame, the second device has a need for P2P transmission in the TXOP sharing mode 2; or
that in a case that no PA field exists in the peer report frame, the second device has no need for P2P transmission in the TXOP sharing mode 2.

In an implementation, the second device further includes:
a third sending unit, configured to return a CTS frame to the first device after the first frame from the first device is received.

The second sending unit is further configured to: send the peer report frame to the first device when SIFS elapses since the reception of the CTS.

In an implementation, the peer report frame includes a QoS control field. For information carried in the QoS control field, reference can be made to the information carried in the QoS control field of the QoS null frame.

In an implementation, the QoS control field of the QoS null frame or the peer report frame includes at least one of the following:
a first subfield, used to indicate that information indicated by the QoS control field is used for a transmission type of the second device; or
a second subfield, used to indicate a length of time that the second device requests the first device to share.

In an implementation, a value of the first subfield represents at least one of following:
the information indicated by the QoS control field is used for uplink transmission from the second device to the first device; or
the information indicated by the QoS control field is used for P2P transmission from the second device to the third device.

In an implementation, in a case that a triggered TXOP sharing support field in an EHT capabilities element of each of the first device and the second device is 1, a QoS control field of the QoS null frame or the peer report frame sent by the second device and received by the first device is used to indicate at least one of following:
that B4 or B7 of the QoS control field is set to a first value, and B8 to B15 of the QoS control field represent a TXOP duration request used for only uplink transmission; or
that B4 or B7 of the QoS control field is set to a second value, and B8 to B15 of the QoS control field represent a TXOP duration request for at least P2P transmission.

In an implementation, the first value is 0, and the second value is 1. Alternatively, the first value is 1, and the second value is 0.

In an implementation, B8 to B15 of the QoS control field indicate a length of time that the second device requests to be shared by the first device.

In an implementation, the eight bits B8 to B15 of the QoS control field indicate a value range of 0 to 255, an indicated time length is in units of 32 μs, and the time length requested by the second device and indicated by B8 to B15 of the QoS control field ranges from 32 μs to 8160 μs, where a value 0 indicated by B8 to B15 of the QoS control field indicates that the second device does not request the first device to allocate time.

In an implementation, the second device further includes:
a third receiving unit, configured to receive a first frame, where the first frame includes the TXOP sharing mode and/or the shared TXOP time.

In an implementation, the TXOP sharing mode and/or the shared TXOP time are/is determined by the first device based on a QoS null frame or a peer report frame from the second device.

In an implementation, the TXOP sharing mode and/or the shared TXOP time are/is directly determined by the first device.

In an implementation, the first frame includes a TXOP sharing mode field, used to indicate the TXOP sharing mode.

In an implementation, a value of the TXOP sharing mode field represents at least one of following:
a TXOP sharing mode 1; or
a TXOP sharing mode 2.

In an implementation, the value of the TXOP sharing mode field is determined based on a first subfield and/or a second subfield in a QoS control field of a QoS null frame or a peer report frame.

In an implementation, a manner of determining the value of the TXOP sharing mode field includes at least one of the following:
that in a case that B4 or B7 of the QoS control field is set to the second value and B8 to B15 of the QoS control field are 0, the TXOP sharing mode field is 1; or
that in a case that B4 or B7 of the QoS control field is set to the second value and B8 to B15 of the QoS control field are not 0, the TXOP sharing mode field is 2.

In an implementation, the value of the TXOP sharing mode field is determined directly by the first device.

In an implementation, the first frame includes a shared TXOP time field, used to indicate the shared TXOP time.

In an implementation, the first frame is an MU-RTS TXS TF.

In an implementation, bidirectional communication is allowed within the shared TXOP time.

In an implementation, in time division mode, the bidirectional communication includes: uplink communication and downlink communication between the first device and the second device at different moments within the shared TXOP time in a case that the TXOP sharing mode is the TXOP sharing mode 1.

In an implementation, in time division mode, the bidirectional communication includes at least one of the following:
uplink communication and downlink communication between the first device and the second device at different moments within the shared TXOP time in a case that the TXOP sharing mode is the TXOP sharing mode 2; or
P2P communication between the second device and the third device at different moments within the shared TXOP time in a case that the TXOP sharing mode is the TXOP sharing mode 2.

In an implementation, the uplink communication and downlink communication between the first device and the second device at different moments within the shared TXOP time includes at least one of the following:
that the first device and the second device alternately send PPDUs within the shared TXOP time; or
that the first device and the second device contend for sending PPDUs in a random backoff DCF manner within the shared TXOP time.

In an implementation, that the first device and the second device alternately send PPDUs within the shared TXOP time includes:
that the second device sends a first PPDU to the first device;
that the second device receives first acknowledgment information that is sent by the first device when SIFS elapses since the reception of the first PPDU;
that the second device receives a second PPDU that is sent by the first device when SIFS elapses since the sending the first acknowledgment information;
that the second device sends second acknowledgment information to the first device; and
when SIFS elapses since the second device sends the second acknowledgment information, the step in which the second device sends a first PPDU to the first device is repeated until the first device and the second device have no PPDU to be sent or the shared TXOP time ends.

In an implementation, the P2P communication between the second device and the third device at different moments within the shared TXOP time includes at least one of the following:
that the second device and the third device alternately send PPDUs within the shared TXOP time; or
that the second device and the third device contend for sending PPDUs in a random backoff DCF manner within the shared TXOP time.

In an implementation, that the second device and the third device alternately send PPDUs within the shared TXOP time includes:
that the second device sends a third PPDU to the third device;
that the second device receives third acknowledgment information that is sent by the third device when SIFS elapses since the reception of the third PPDU;
that the second device receives a fourth PPDU that is sent by the third device when SIFS elapses since the sending the third acknowledgment information;
that the second device sends fourth acknowledgment information to the third device; and
when SIFS elapses since the second device sends the fourth acknowledgment information, the step in which the second device sends a third PPDU to the third device is repeated until the second device and the third device have no PPDU to be sent or the shared TXOP time ends.

In an implementation, the acknowledgment information is an acknowledgment Ack frame or a block acknowledgment BlockAck frame.

In an implementation, in frequency division mode, the bidirectional communication includes: uplink communication and downlink communication between the first device and the second device on different RUs within the shared TXOP time in a case that the TXOP sharing mode is the TXOP sharing mode 1.

In an implementation, in frequency division mode, the bidirectional communication includes at least one of the following:
uplink communication and downlink communication between the first device and the second device on different RUs within the shared TXOP time in a case that the TXOP sharing mode is the TXOP sharing mode 2; or
P2P communication between the second device and the third device on different RUs within the shared TXOP time in a case that the TXOP sharing mode is the TXOP sharing mode 2.

In an implementation, the uplink communication and downlink communication between the first device and the second device on different RUs within the shared TXOP time includes:
receiving, by the second device, a first PPDU that is sent by the first device on a first RU; and
returning, by the second device, a second PPDU on a second RU to the first device.

In an implementation, the P2P communication between the second device and the third device on different RUs within the shared TXOP time includes:
receiving, by the second device, a third PPDU that is sent by the third device on a third RU; and returning, by the second device, a fourth PPDU on a fourth RU to the third device.

In an implementation, the second device further includes: a fourth sending unit, configured to send information of a third device, where the third device is a peer device with which the second device performs P2P communication.

In an implementation, the first frame is an MU-RTS TF.

In an implementation, a common information field of the first frame is used to indicate that the first frame is an MU-RTS TF.

In an implementation, a value of a trigger type subfield in the common information field is set to 3, indicating that the first frame is an MU-RTS TF.

In an implementation, a TXOP sharing mode field of the MU-RTS TF reuses 2 bits of the common information field.

In an implementation, the TXOP sharing mode field reuses B20 and B21 of the common information field.

In an implementation, in a case that the TXOP sharing mode field of the MU-RTS TF has a non-zero value, the MU-RTS TF is an MU-RTS TXS TF.

In an implementation, in a case that a value of the TXOP sharing mode field is 1, 2, or 3, the MU-RTS TF is an MU-RTS TXS TF.

In an implementation, a user information list field of the first frame includes at least one of the following:
that an AID12 subfield in a first user information field is used to indicate 12 least significant bits of an AID of the second device; or
that an AID12 subfield in a second user information field is used to indicate 12 least significant bits of an AID of a third device.

In an implementation, a user information list field of the first frame includes at least one of the following:
that an allocation duration subfield in a third user information field is used to indicate first duration allocated by the first device to the second device; or
that a value of an allocation duration subfield in a fourth user information field is the first duration, which indicates that the third device and the second device share same duration.

In an implementation, the common information field of the first frame includes an uplink length subfield; and the uplink length subfield includes an allocation duration subfield, and the allocation duration subfield is used to indicate first duration allocated by the first device to the second device and/or the third device.

In an implementation, a user information field of the first frame includes:
an RU allocation subfield, used to indicate an RU used by the second device and/or an RU used by the third device.

In an implementation, in time division mode, the RU used by the second device and/or the RU used by the third device indicated in the RU allocation subfield are identical.

In an implementation, in frequency division mode, the RU used by the second device and/or the RU used by the third device indicated in the RU allocation subfield are different.

The second device 1000 in this embodiment of this application can implement a corresponding function of the second device in the embodiment of the foregoing method 600. For procedures, functions, implementations, and beneficial effects corresponding to modules (submodules, units, components or the like) in the second device 1000, reference can be to corresponding descriptions in the foregoing method embodiments. Details are not described herein again. It should be noted that functions of modules (submodules, units, components or the like) in the second device 1000 in this embodiment of this application may be implemented by different modules (submodules, units, components or the like), or may be implemented by a same module (submodule, unit, component or the like).

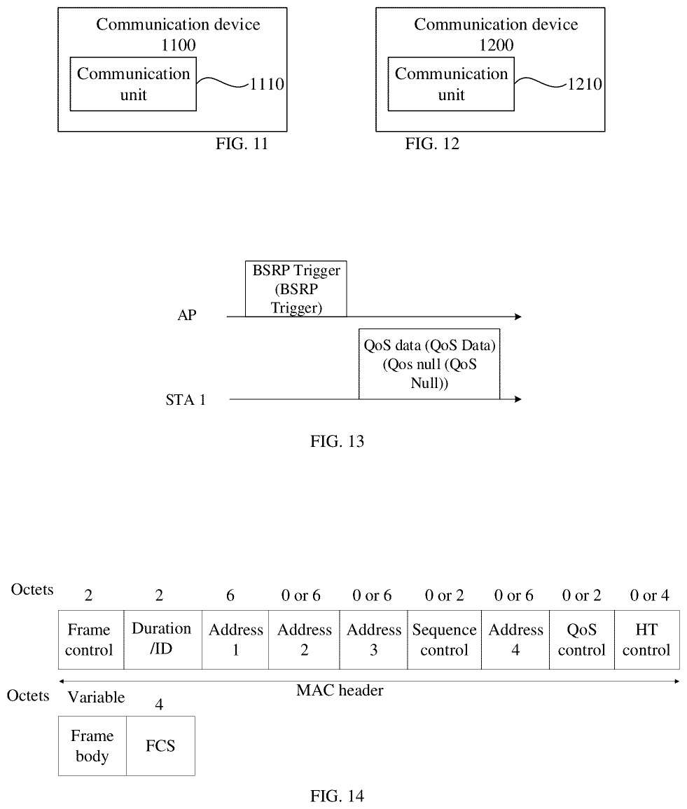

FIG. 11 is a schematic block diagram of a communication device 1100 according to an embodiment of this application. The communication device 1100 may include:
a communication unit 1110, configured to receive and/or send a peer report frame, where the peer report frame is used to report information of a third device that is on a peer end and that is about to perform P2P communication with a second device.

In an implementation, the communication device is a first device, for example, an AP. A communication unit of the first device is a receiving unit. The receiving unit is configured receive a peer report frame from the second device, for example, a STA.

In an implementation, the communication device is the second device, for example, a STA. A communication unit of the second device is a sending unit. The sending unit is configured to send the peer report frame to the first device, for example, an AP.

In an implementation, the peer report frame includes: a PA field, where the PA field is used to indicate a MAC address of the third device on the peer end of the second device.

In an implementation, in a case that the peer report frame is proactively reported by the second device, the PA field exists in the peer report frame.

In an implementation, in a case that the peer report frame is a response of the second device after the first device sends a peer device collection frame, the peer report frame includes at least one of the following:
that in a case that the PA field exists in the peer report frame, the second device has a need for P2P transmission in the TXOP sharing mode 2; or
that in a case that no PA field exists in the peer report frame, the second device has no need for P2P transmission in the TXOP sharing mode 2.

In an implementation, the peer report frame includes a QoS control field. For information carried in the QoS control field, reference can be made to the information carried in the QoS control field of the QoS null frame.

In an implementation, the QoS control field of the peer report frame includes at least one of the following:
a first subfield, used to indicate that information indicated by the QoS control field is used for a transmission type of the second device; or
a second subfield, used to indicate a length of time that the second device requests the first device to share.

In an implementation, a value of the first subfield represents at least one of following:
that the information indicated by the QoS control field is used for uplink transmission from the second device to the first device; or
that the information indicated by the QoS control field is used for P2P transmission from the second device to the third device.

In an implementation, in a case that a triggered TXOP sharing support field in an EHT capabilities element of each of the first device and the second device is 1, a QoS control field of the peer report frame sent by the second device and received by the first device is used to indicate at least one of following:
that B4 or B7 of the QoS control field is set to a first value, and B8 to B15 of the QoS control field represent a TXOP duration request used for only uplink transmission; or
that B4 or B7 of the QoS control field is set to a second value, and B8 to B15 of the QoS control field represent a TXOP duration request for at least P2P transmission.

In this embodiment of this application, B4 and/or B7 of the QoS control field of the peer report frame may be a first subfield of the QoS control field, and B8 to B15 of the QoS control field may be a second subfield of the QoS control field.

In this embodiment of this application, B4 and/or B7 of the QoS control field may be a first subfield of the QoS control field, and B8 to B15 of the QoS control field may be a second subfield of the QoS control field.

In an implementation, the first value is 0, and the second value is 1. Alternatively, the first value is 1, and the second value is 0.

In an implementation, B8 to B15 of the QoS control field indicate a length of time that the second device requests to be shared by the first device.

In an implementation, the eight bits B8 to B15 of the QoS control field indicate a value range of 0 to 255, an indicated time length is in units of 32 μs, and the time length requested by the second device and indicated by B8 to B15 of the QoS control field ranges from 32 μs to 8160 μs.

In an implementation, a value 0 indicated by B8 to B15 of the QoS control field indicates that the second device does not request the first device to allocate time.

The communication device 1100 in this embodiment of this application can implement a corresponding function of the communication device in the embodiment of the foregoing method 700. For procedures, functions, implementations, and beneficial effects corresponding to modules (submodules, units, components or the like) in the communication device 1100, reference can be to corresponding descriptions in the foregoing method embodiments. Details are not described herein again. It should be noted that functions of modules (submodules, units, components or the like) in the communication device 1100 in this embodiment of this application may be implemented by different modules such as (submodules, units, components or the like), or may be implemented by a same module (submodule, unit, component or the like).

FIG. 12 is a schematic block diagram of a communication device 1200 according to an embodiment of this application. The communication device 1200 may include:
a communication unit 1210, configured to send and/or receive a first frame, where the first frame includes a shared TXOP time and/or a TXOP sharing mode.

In an implementation, the communication device is a first device, for example, an AP. A communication unit of the first device is a sending unit. The sending unit is configured to send the first frame to the second device, for example, an STA.

In an implementation, the communication device is the second device, for example, a STA. A communication unit of the second device is a receiving unit. The receiving unit is configured receive the first frame from the first device, for example, an AP.

In an implementation, the TXOP sharing mode and/or the shared TXOP time are/is determined by the first device based on a QoS null frame or a peer report frame from the second device.

In an implementation, the TXOP sharing mode and/or the shared TXOP time are/is directly determined by the first device.

In an implementation, the first frame includes a TXOP sharing mode field, used to indicate the TXOP sharing mode.

In an implementation, a value of the TXOP sharing mode field represents at least one of following:
a TXOP sharing mode 1; or
a TXOP sharing mode 2.

In an implementation, the value of the TXOP sharing mode field is determined based on a first subfield and/or a second subfield in a QoS control field of a QoS null frame or a peer report frame.

In an implementation, a manner of determining the value of the TXOP sharing mode field includes at least one of the following:
that in a case that B4 or B7 of the QoS control field is set to the second value and B8 to B15 of the QoS control field are 0, the TXOP sharing mode field is 1; or
that in a case that B4 or B7 of the QoS control field is set to the second value and B8 to B15 of the QoS control field are not 0, the TXOP sharing mode field is 2.

In an implementation, the value of the TXOP sharing mode field is determined directly by the first device.

In an implementation, the first frame is an MU-RTS TF.

In an implementation, a common information field of the first frame is used to indicate that the first frame is an MU-RTS TF.

In an implementation, a value of a trigger type subfield in the common information field is set to 3, indicating that the first frame is an MU-RTS TF.

In an implementation, a TXOP sharing mode field of the MU-RTS TF reuses 2 bits of the common information field.

In an implementation, the TXOP sharing mode field reuses B20 and B21 of the common information field.

In an implementation, in a case that the TXOP sharing mode field has a non-zero value, the MU-RTS TF is an MU-RTS TXS TF.

In an implementation, in a case that a value of the TXOP sharing mode field is 1, 2, or 3, the MU-RTS TF is an MU-RTS TXS TF.

In an implementation, a user information list field of the first frame includes at least one of the following:
that an AID12 subfield in a first user information field is used to indicate 12 least significant bits of an AID of the second device; or
that an AID12 subfield in a second user information field is used to indicate 12 least significant bits of an AID of a third device.

In an implementation, a user information list field of the first frame includes at least one of the following:
that an allocation duration subfield in a third user information field is used to indicate first duration allocated by the first device to the second device; or
that a value of an allocation duration subfield in a fourth user information field is the first duration, which indicates that the third device and the second device share the same duration.

In an implementation, the common information field of the first frame includes an uplink length subfield; and the uplink length subfield includes an allocation duration subfield, and the allocation duration subfield is used to indicate first duration allocated by the first device to the second device and/or the third device.

In an implementation, a user information field of the first frame includes:
an RU allocation subfield, used to indicate an RU used by the second device and/or an RU used by the third device.

In an implementation, in time division mode, the RU used by the second device and/or the RU used by the third device indicated in the RU allocation subfield are identical.

In an implementation, in frequency division mode, the RU used by the second device and/or the RU used by the third device indicated in the RU allocation subfield are different.

The communication device 1200 in this embodiment of this application can implement a corresponding function of the communication device in the embodiment of the foregoing method 800. For procedures, functions, implementations, and beneficial effects corresponding to modules (submodules, units, components or the like) in the communication device 1200, reference can be made to corresponding descriptions in the foregoing method embodiments. Details are not described herein again. It should be noted that functions of modules (submodules, units, components or the like) in the communication device 1200 in this embodiment of this application may be implemented by different modules (submodules, units, components or the like), or may be implemented by a same module (submodule, unit, component or the like).

No related mechanism provides information on how a STA indicates shared TXOP time requirements for uplink transmission and P2P transmission of the STA, or provides information to guide the AP to select a TXOP sharing mode 1 and a TXOP sharing mode 2. This application may provide related indication signaling and mode selection methods.

In the TXOP sharing mode 2, due to existence of uplink transmission and P2P transmission, the AP needs to wait for the end of the shared time before sending. This application proposes to perform P2P transmission first and then uplink transmission, so that the AP can follow rules of the TXOP sharing mode 1, thereby saving a TXOP time.

In both modes, a related mechanism does not allow the AP or a peer STA to respond to a data frame. This application can provide a bidirectional data transmission mechanism for triggered transmission opportunity sharing (Triggered TXOP sharing).

This application may provide an example of a specific communication method, and the communication method is an enhanced method for triggered TXOP sharing. The method mainly includes at least one of the following parts:

Part (I) describes methods for how a STA indicates TXOP sharing time requirements and how an AP selects a TXOP sharing mode.

Part (II) describes a method for modifying uplink transmission and P2P transmission rules of the STA in a TXOP sharing mode 2, to be able to use a TXOP sharing mode 1, thereby saving a remaining time of a time allocated by the AP.

Parts (III) and (IV) describe how to allow the AP or a peer STA to return a PPDU after the AP shares a TXOP with the STA for sending a non-TB PPDU.

Part (V) describes several frame formats.

Detailed described are separately given below.

### (I) Methods for how a STA Indicates Shared TXOP Time Requirements and how an AP Selects a TXOP Sharing Mode

As shown in FIG. 13, before performing triggered TXOP sharing, the AP may send a BSRP trigger frame to the STA, and the STA returns a QoS null frame to the AP. In another implementation, alternatively, in a case that the AP does not send a BSRP TF, the STA may proactively send a QoS data frame (where a QoS null frame type in the QoS data frame is used as an example in FIG. 13) to the AP.

FIG. 14 shows a structure of a typical MAC frame, where when a type value of a frame control field is set to 2 (that is, B3 B2=10) and a subtype value is set to 12 (that is, B7 B6 B5 B4=1100), the frame is defined as a QoS null frame. In this case, both the QoS control field and the HT control field exist.

For example, as shown in Table 1, a QoS control field of the QoS null frame indicates the following information:
that Bit 4 (or Bit 7) (Bit 4 may be referred to as B4, and Bit 7 may be referred to as B7) is set to 0, indicating that information indicated by the QoS Control field is used to instruct the STA to perform uplink transmission;
that Bit 4 (or Bit 7) is set to 1, indicating that information indicated by the QoS Control field is used to instruct the STA to perform P2P transmission;
that Bits 0 to 3 (B0 to B3 for short) indicate a channel bandwidth of transmission that the STA requests to perform within a time period shared by the AP;
that Bits 0 to 3 are set to 0, indicating 20 MHz; bits 0 to 3 are set to 1, indicating 40 MHz; and bits 0 to 3 are set to 2, indicating 80 MHz;
that Bits 0 to 3 are set to 3, indicating 160 MHz; bits 0 to 3 are set to 4, indicating 320 MHz; and bits 0 to 3 are set to 5 to 7, indicating reserved bits.
Bits 8 to 15 (B8 to B15 for short) indicate a length of time that the STA requests to be shared by the AP.

Because bits 8 to 15 have eight bits, a value that can be indicated ranges from 0 to 255. If a time length indicated by bits 8 to 15 is in units of 32 μs, a time length that is requested by the STA and that can be indicated ranges from 32 μs to 8160 μs, where 0 means that the STA does not request the AP to allocate time.

In addition, meaning of values of bit 4 and bit 7 may also be changed. For example:
bit 4 (or bit 7) is set to 1, indicating that information indicated by the QoS Control field is used to instruct the STA to perform uplink transmission; or
bit 4 (or bit 7) is set to 0, indicating that information indicated by the QoS Control field is used to instruct the STA to perform P2P transmission.

TABLE 1
QoS control field

| | Bits | | Bits | | |
|---|---|---|---|---|---|
| Applicable frame (sub)types | 0 to 3 | Bit 4 | 5 to 6 | Bit 7 | Bits 8 to 15 |
| QoS null frame sent by the STA | Channel | 0 | Ack | Reserved | TXOP Duration |
| to the AP when a triggered | width | | Policy | | Requested for UL |
| TXOP sharing support field in | | | Indicator | | Transmission Only |
| an EHT capabilities element of | | | | | |
| each of the AP and the STA is | | | | | |
| equal to 1 | | | | | |
| QoS null frame sent by the STA | Channel | 1 | Ack | Reserved | TXOP Duration |
| to the AP when a triggered | Width | | Policy | | Requested at least |
| TXOP sharing support field in | | | Indicator | | for P2P |
| an EHT capabilities element of | | | | | Transmission |
| each of the AP and the STA is | | | | | |
| equal to 1 | | | | | |

After the STA sends its requested resource (for example, channel bandwidth and TXOP duration request used for at least P2P transmission) used for P2P to the AP through a QoS null frame, the AP may determine, based on the following principle, a TXOP sharing mode to be used in an MU-RTS TXS TF frame. For example:
if bit 4 of the QoS null frame is set to 1 (indicating that the information indicated by the QoS Control field is used for P2P transmission of the STA), and bits 8 to 15 indicate that the TXOP duration request used for at least P2P transmission is 0, it may indicate that the STA has no need for P2P transmission, and the AP may set a TXOP sharing mode in an MU-RTS TXS TF to 1; or
if bit 4 of the QoS null frame is set to 1 (indicating that the information indicated by the QoS Control field is used for P2P transmission of the STA), and bits 8 to 15 indicate that the TXOP duration request used for at least P2P transmission is not equal to 0, it may indicate that the STA has a need for P2P transmission, and the AP may set a TXOP sharing mode in an MU-RTS TXS TF to 2.
   (II) First Performing P2P Transmission and then Performing Uplink Transmission in a TXOP Sharing Mode 2

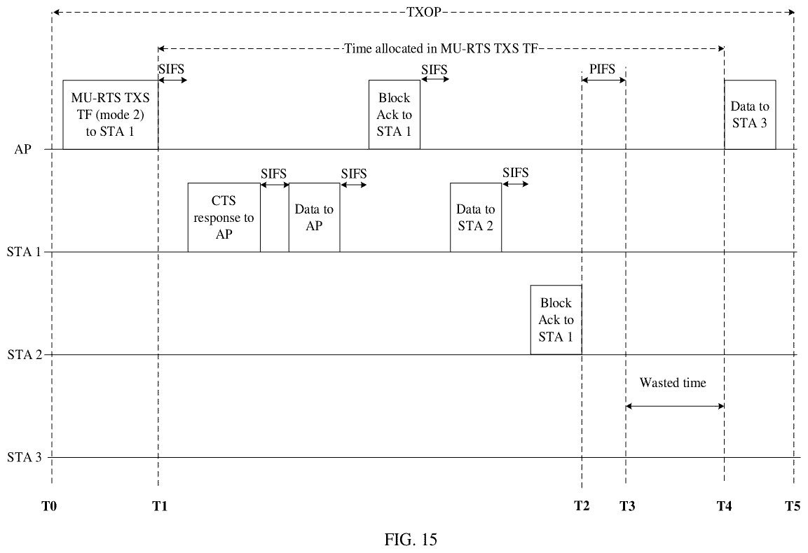

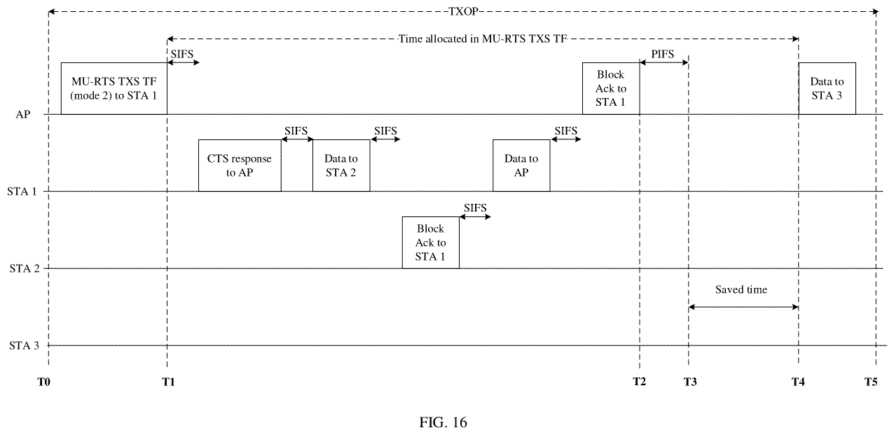

As shown in FIG. 15 and FIG. 16, TO is a start time of a TXOP, which lasts until time T5, obtained by the AP. The AP shares, through an MU-RTS TXS TF, a portion (for example, from time T1 to time T4) of the TXOP time obtained by the AP with STA 1.

As shown in FIG. 15 and FIG. 16, the AP sends an MU-RTS TXS TF to STA 1 (at time T1). Between time T1 and time T2, STA 1 sends a CTS response frame and a data frame to the AP, the AP sends a block acknowledgment frame to STA 1, STA 1 sends a data frame to STA 2, and STA 2 sends a block acknowledgment frame to STA 1 (at time T2).

As shown in FIG. 15, in the TXOP sharing mode 2, the STA first performs uplink transmission and then performs P2P transmission. In the TXOP sharing mode 2, even if STA 1 has completed sending all frames at time T2 and has no other frames to send, if the AP is not allowed to send frames before the end (for example, time T4) of a time shared by the AP, the time from T3 to T4 in the TXOP obtained by the AP is wasted. The time from T3 to T4 is wasted time.

In this embodiment of this application, the following modifications are made to the TXOP sharing mode 2:

(1) Rules for an order of P2P transmission and uplink transmission performed by the STA in the TXOP sharing mode 2 are modified, for example, as follows:

Option 1: The STA performs only uplink transmission if there is only uplink transmission in the TXOP sharing mode 2.

Option 2: The STA performs P2P transmission if there is only P2P transmission in the TXOP sharing mode 2.

Option 3: The STA performs P2P transmission first and then uplink transmission if there are both uplink transmission and P2P transmission in the TXOP sharing mode 2.

(2) If the AP sends an MU-RTS TXS TF carrying a TXOP sharing mode subfield=2 to the STA and then receives a CTS frame returned by the STA, the AP is not allowed to send any PPDU within a time shared with the STA and indicated in the MU-RTS TXS TF, except in the following cases:
where the STA sends a PPDU that requires an immediate response; or
where within a PIFS time after the AP completes sending an immediate response frame to the STA or receives a frame that is sent by the STA and that does not require an immediate response, a carrier sensing mechanism detects that a channel medium is idle.

According to the foregoing Rule (2), under Option 1 and Option 3 of Rule (1), as shown in FIG. 16, P2P transmission is performed first and then uplink transmission is performed in the TXOP sharing mode 2. Because the STA performs uplink transmission to the AP at last, after the STA completes sending all frames within a time (that is, at T2) shared by the AP, if the AP detects that the channel medium is idle in a PIFS time (from time T2 to time T3) within the time shared by the AP, the AP can send other frames (for example, data sent to STA 3) after the PIFS (that is, time T3). In addition, the AP may send other frames within a PIFS time after the AP completes sending an immediate response frame to the STA or receives a frame that is sent by the STA and that does not require an immediate response in a case that the carrier sensing mechanism detects that the channel medium is idle. Therefore, the AP does not need to wait until the shared time ends (that is, time T4) to send other frames. In Option 2, because there is only P2P transmission of the STA, the AP cannot receive any frame, and the AP needs to continue to wait for the shared time to end (that is, time T4) before sending other frames (for example, data sent to STA 3).

Therefore, according to Rules (1) and (2), if there is uplink transmission of the STA in the TXOP sharing mode 2 and is scheduled to be performed at last, a time period that can be saved in this embodiment of this application is: from the PIFS time (that is, time T3) after the STA ends using the time shared by the AP to an end time (that is, time T4) of the time shared by the AP. That is, the time from T3 to T4 is saved time.

(III) Sharing a Portion of a TXOP Time by an AP with a STA for Bidirectional Communication (Time Division Method)

If a triggered TXOP sharing mechanism allows to perform only unidirectional communication in both mode 1 and mode 2, it is not conducive to providing a good experience for delay-sensitive services (for example, AR/VR). Therefore, an embodiment of the present disclosure proposes that the AP shares a portion of time of its obtained TXOP with a STA for bidirectional communication. In this way, a communication delay can be reduced. In the time division method, different TXOP sharing modes may be classified into the following two cases.

### 3.1 TXOP Sharing Mode 1

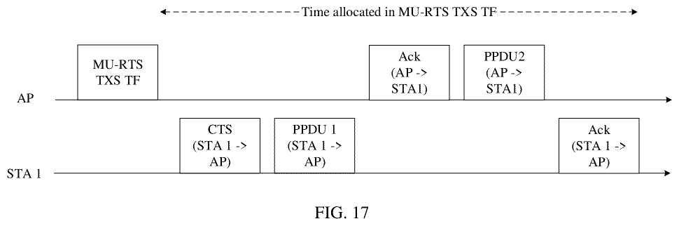

The AP shares a portion of its obtained TXOP with a STA for use, where a use rule is that the STA is allowed to send only an uplink non-TB PPDU to the AP. In order to achieve bidirectional communication of the STA, a rule on the AP side under the triggered TXOP sharing mechanism can be modified. As shown in FIG. 17, the AP and the STA perform bidirectional communication.

Modified rule: In the TXOP sharing mode 1, the AP shares, through an MU-RTS TXS TF, a portion of its obtained TXOP with a STA for sending a non-TB PPDU to the AP; and the AP may also use the time shared with the STA to send a PPDU to the STA.

As shown in FIG. 17, because both the AP and STA 1 can perform sending within an allocated time, when a SIFS time elapses since the AP sends an Ack, both STA 1 and the AP may send frames at the same time, which causes a transmission conflict. To resolve this problem, this embodiment of this application proposes the following options:

Option 1: A sending sequence for the AP and the STA is forcibly set, and the AP and STA alternately send PPDUs. As shown in FIG. 17, for example, the AP sends an Ack when a SIFS time elapses since the reception of PPDU 1 from STA 1, and sends a next PPDU 2 when a SIFS time elapses since the sending the Ack. Then STA 1 returns an Ack, and when a SIFS time elapses since the sending the Ack, STA 1 continues to send a PPDU; and so on, until the AP and/or STA 1 have/has no frames to send, or a time allocated by the AP ends.

Option 2: The AP and the STA contend for sending PPDUs in a random backoff (Distributed Coordination Function, DCF) manner within an allocated time.

### 3.2 TXOP Sharing Mode 2

In order that the AP shares a portion of time of a TXOP with the STA for P2P bidirectional communication, the AP needs to know a peer STA of the STA, and then allocate the same time period in the TXOP to the peer STA through an MU-RTS TXS TF. Therefore, an address of the peer STA may be indicated in the MU-RTS TXS TF. An example of an implementation method is as follows:

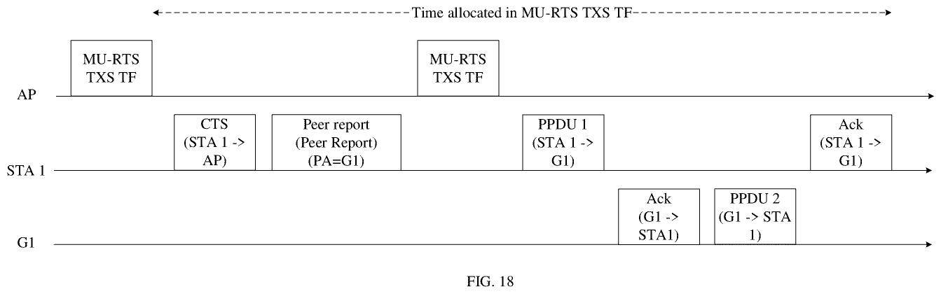

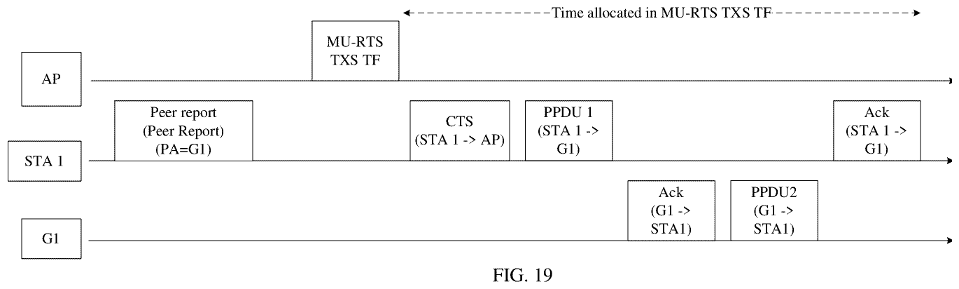

As shown in FIG. 18, the AP may resend an MU-RTS TXS TF after learning of the peer STA of the STA. After the AP sends an MU-RTS TXS TF, the STA first returns a CTS and then proactively informs, through a newly provided frame, for example, a peer report frame after the SIFS time, the AP of information of a peer STA with which the STA needs to exchange data. Then the AP sends an MU-RTS TXS TF to share this period of time again with the target STA and the peer STA of the target STA.

Modified rule: In the TXOP sharing mode 2, the AP shares, through an MU-RTS TXS TF, a portion of its obtained TXOP with a STA for sending a non-TB PPDU to the AP; and at the same time, the AP may also use the time shared with the STA to send a PPDU to the STA. In addition, the AP shares, through an MU-RTS TXS TF, a portion of its obtained TXOP with the STA for sending a non-TB PPDU to the peer STA; and the peer STA may also use the time shared with the STA to send a PPDU to the STA.

As shown in FIG. 18, G1 is the peer STA that is about to perform P2P communication with STA 1. Because both STA 1 and G1 can perform sending within an allocated time, when a SIFS time elapses since G1 sends an Ack, both STA 1 and G1 may send frames at the same time, which may cause a conflict. To resolve this problem, this application proposes the following options:

Option 1: A sending sequence for STA 1 and G1 is forcibly set, and STA 1 and G1 alternately send PPDUs. For example, G1 sends an Ack when a SIFS time elapses since the reception of PPDU 1 from STA 1, and sends a next PPDU 2 to G1 when a SIFS time elapses since the sending the Ack. Then STA 1 returns an Ack, and when a SIFS time elapses since the sending the Ack, STA 1 continues to send a PPDU; and so on, until STA 1 and/or G1 have/has no frames to send, or a time allocated by the AP ends.

Option 2: STA 1 and G1 contend for sending PPDUs in a random backoff (Distributed Coordination Function, DCF) manner within an allocated time.

### 3.3 Alternatives to 3.2

For 3.2 TXOP sharing mode 2, two additional methods are provided:

Alternative 1: The STA proactively informs the AP of a peer STA of the STA (time division method). As shown in FIG. 19, before the AP sends an MU-RTS TXS TF, the STA proactively informs, through a newly provided frame, for example, a peer report frame, the AP of a peer STA with which the STA needs to exchange PPDUs. In this case, a time allocated by the AP can be used for PPDU exchange between the target STA, for example, STA 1, and the peer STA of the target STA, for example, G1.

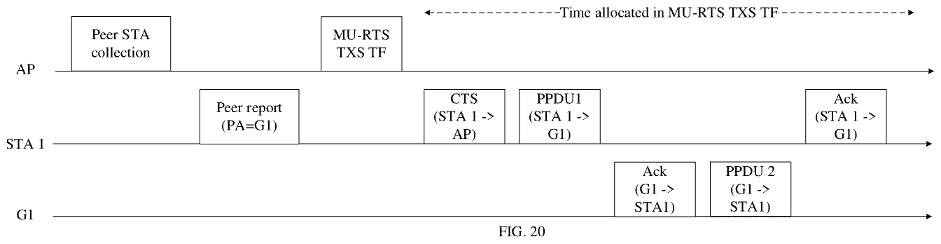

Alternative 2: The AP inquires the peer STA of the STA in FIG. 20 (time division method). As shown in FIG. 20, the AP may send a peer STA collection frame (Peer STA Collect) frame to request the target STA to feed back information of the peer STA of the target STA before sending an MU-RTS TXS TF to execute the triggered TXOP sharing mechanism.

(IV) Sharing a Portion of a TXOP Time by an AP with a STA for Bidirectional Communication (Frequency Division Method)

A conventional triggered TXOP sharing mechanism allows to perform only unidirectional communication in both mode 1 and mode 2, which is not conducive to providing a good experience for delay-sensitive services (for example, AR/VR). Therefore, this section proposes that the AP shares a portion of frequencies of its obtained TXOP with a STA for bidirectional communication. An advantage thereof is to reduce a communication delay. In the frequency division method, different TXOP sharing modes may be classified into the following two cases.

### 4.1 TXOP Sharing Mode 1

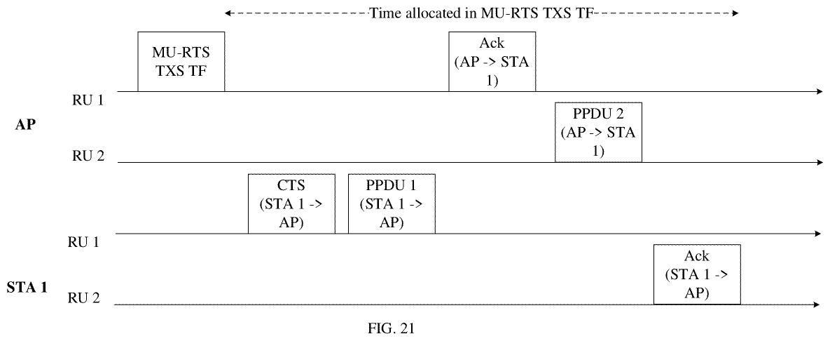

The AP shares, with the STA through an MU-RTS TXS TF, a same time period of a TXOP but with different RUs. As shown in FIG. 21, the MU-RTS TXS TF sent by the AP instructs the STA to send a non-TB PPDU (for example, PPDU 1) on one of RUs (for example, RU 1) to the AP, and the AP returns a PPDU (for example, PPDU 2) to the STA on another RU (for example, RU 2). In addition, after receiving PPDU 1, the AP may return an Ack on RU 1 to STA 1. After receiving PPDU 2, STA 1 may return an Ack on RU 2 to the AP.

### 4.2 TXOP Sharing Mode 2

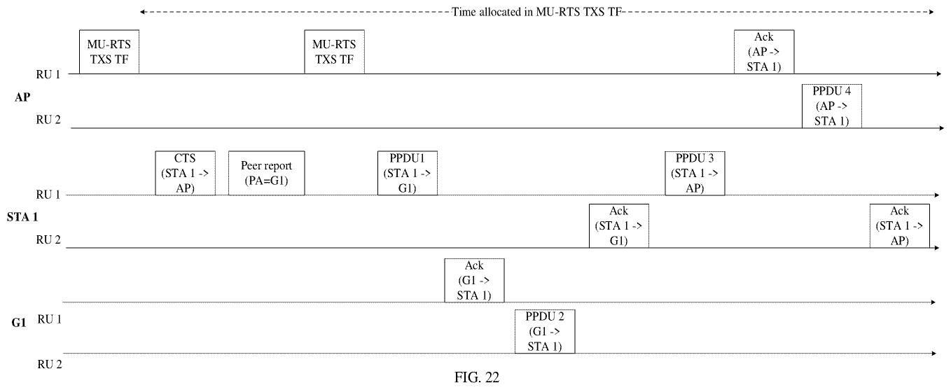

The AP shares, with a pair of devices through an MU-RTS TXS TF, a same time period of a TXOP but with different RUs. As shown in FIG. 22, the MU-RTS TXS TF sent by the AP instructs STA 1 to send a non-TB PPDU (for example, PPDU 1) on one of RUs (for example, RU 1) to G1 (that is, the peer STA). G1 returns a PPDU (for example, PPDU 2) on another RU (for example, RU 2) to STA 1. In addition, the MU-RTS TXS TF sent by the AP in the TXOP sharing mode 2 may further instruct STA 1 to send a non-TB PPDU (for example, PPDU 3) on one of RUs (for example, RU 1) to the AP, and the AP returns a PPDU (for example, PPDU 4) on another RU (for example, RU 2) to the STA. In addition, after receiving PPDU 1, G1 may return an Ack on RU 1 to STA 1. After receiving PPDU 2, STA 1 may return an Ack on RU 2 to G1. After receiving PPDU 3, the AP may return an Ack on RU 1 to STA 1. After receiving PPDU 4, STA 1 may return an Ack on RU 2 to the AP.

### 4.3 Alternatives to 4.2

For 4.2 TXOP sharing mode 2, two additional methods are provided:

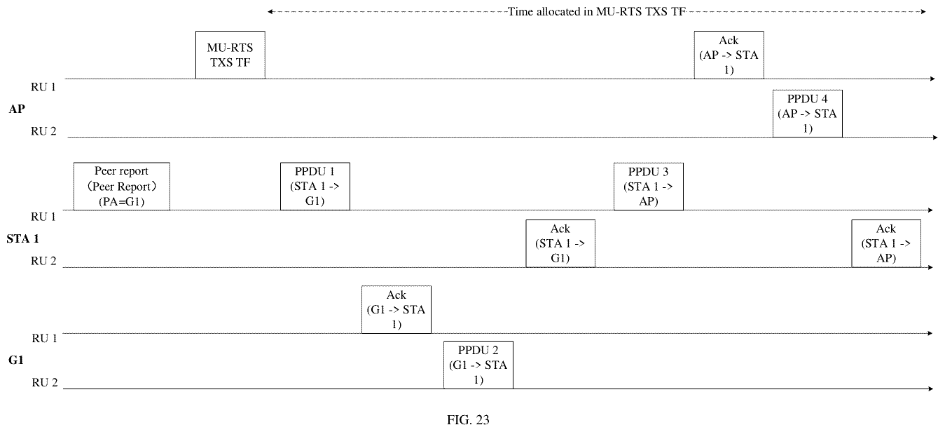

Alternative 1: The STA proactively informs the AP of a peer STA of the STA (frequency division method). As shown in FIG. 23, before the AP sends an MU-RTS TXS TF, the STA, for example, STA 1 proactively informs, through a newly provided frame such as a peer report frame, the AP of information (for example, PA in the peer report frame=MAC address of G2) of a peer STA, for example, G2, with which the STA needs to exchange PPDUs. Therefore, an RU allocated by the AP can be used for PPDU exchange between the target STA and the peer STA of the target STA.

In addition, STA 1 may send PPDU 1 on RU 1 to G1, and G1 may return an Ack on RU 1 to STA 1. G1 may send PPDU 2 on RU 2 to STA 1, and STA 1 may return an Ack on RU 2 to G1. STA 1 may send PPDU 3 on RU 1 to the AP, and the AP may return an Ack on RU 1 to STA 1. The AP may send PPDU 4 on RU 2 to STA 1, and STA 1 may return an Ack on RU 2 to the AP.

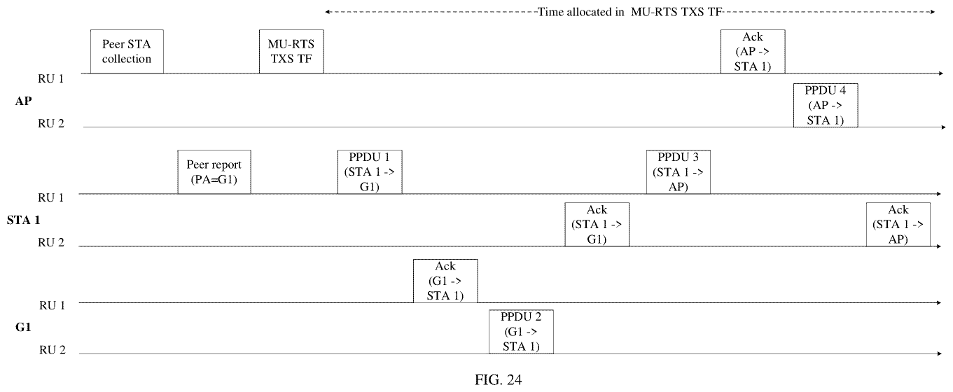

Alternative 2: The AP inquires the peer STA of the STA (frequency division method). As shown in FIG. 24, the AP may send a peer STA collection frame (Peer STA Collect) frame to request the target STA such as STA 1 to feed back information (PA in the peer report frame=MAC address of G1) of the peer STA, such as G1, of the target STA before sending an MU-RTS TXS TF to execute the triggered TXOP sharing mechanism.

In addition, STA 1 may send PPDU 1 on RU 1 to G1, and G1 may return an Ack on RU 1 to STA 1. G1 may send PPDU 2 on RU 2 to STA 1, and STA 1 may return an Ack on RU 2 to G1. STA 1 may send PPDU 3 on RU 1 to the AP, and the AP may return an Ack on RU 1 to STA 1. The AP may send PPDU 4 on RU 2 to STA 1, and STA 1 may return an Ack on RU 2 to the AP.

### 4.4 Technical Solution Extension for Combined Use of a QoS Null Frame and a Peer Report Frame

Both Part (III) and Part (IV) include: the STA sends a peer report frame to the AP to inform the AP of the MAC address of the peer STA. The QoS control field of the peer report frame may also carry information carried by the QoS control field of the QoS null frame in Part (I). For example, the QoS control field of the peer report frame returned by the STA after the AP sends the peer STA collect frame, or the peer report frame proactively sent by the STA to the AP carries the information in Table 1, to assist the AP in selecting a TXOP sharing mode.

### Part (V) Frame Formats

5.1 Peer report frame

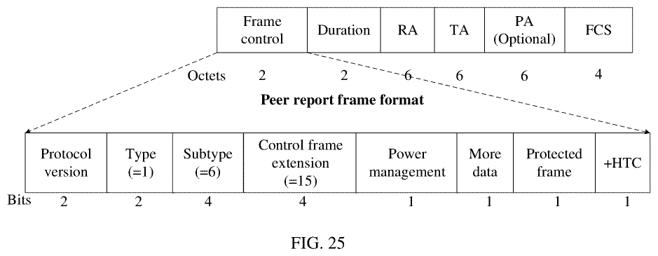

As shown in FIG. 25, a new control frame is provided, where a value 1 of a frame type indicates that the frame is a control frame, and a value 6 of a frame subtype indicates that the frame is an extended control frame. A value 15 (which may be any value from 12 to 15) of a control frame extension indicates that the frame is a control frame of a peer report frame. In a triggered TXOP sharing mechanism, the peer report frame is used for a STA to report, to the AP, a MAC address of a peer STA with which the STA is about to perform P2P communication. The MAC address of the peer STA is indicated by a PA field.

For Alternative 1 in 3.3, 3.2, 4.2 and Alternative 1 in 4.3, the PA field definitely exists in a peer report frame proactively sent by the STA.

For Alternative 2 in 3.3 and Alternative 2 in 4.3, the PA field does not necessarily exist in a peer report frame returned by the STA after the AP sends a peer STA collect frame.

If the PA field exists, it indicates that the AP has a need for P2P transmission in a TXOP sharing mode 2.

If the PA field does not exist, it indicates that the AP has no need for P2P transmission in a TXOP sharing mode 2.

### 5.2 MU-RTS TXS TF

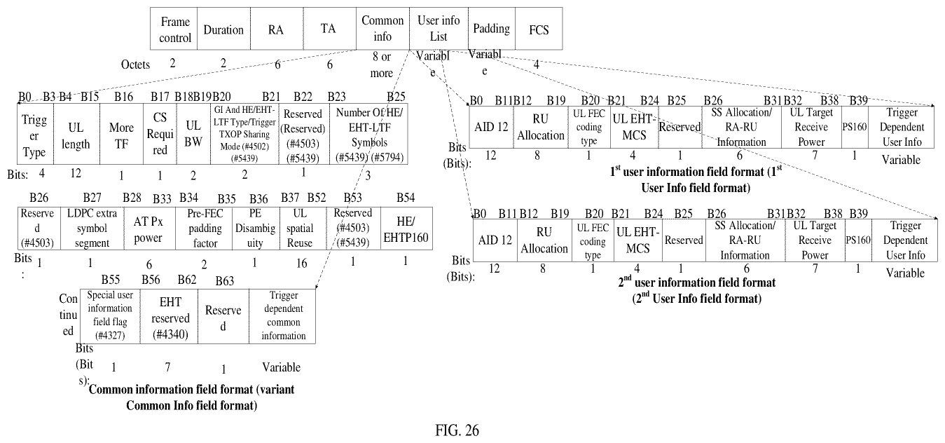

FIG. 26 shows a structure of a trigger frame. In the trigger frame, when a value of a trigger type subfield in a common information field is set to 3, the trigger frame is defined as an MU-RTS TF. The Common Info field of the MU-RTS TF may reuse existing two bits (for example, B20 and B21) to define a new TXOP sharing mode subfield. When the TXOP sharing mode subfield has a non-zero value (for example, 1 or 2 or 3), the MU-RTS TF is defined as an MU-RTS TXS TF structure.

Method for indicating the STA and the peer STA by an MU-RTS TXS TF (corresponding to Part (III) and Part (IV)):

AID12 subfields of two user information fields in a user information list field are used to respectively indicate 12 least significant bits of an AID of the STA and 12 least significant bits of an AID of the peer STA of the STA.

The AID12 subfield in the user information field is equal to 12 least significant bits (LSBs) of an AID of the STA.

Method for indicating allocation of time resources to the STA and the peer STA by an MU-RTS TXS TF (corresponding to Part (III)):

### Solution 1: Using Two User Information Fields (User Info Field) for Respective Indication

B20 to B38 (a total of 19 bits) of the user information field of the MU-RTS TXS TF may be redefined. For example, i bits (bits) (7 or 12 bits, not a specified limitation) thereof may be redefined to serve as an allocation duration subfield to indicate time duration allocated by the AP to the STA. Allocation duration subfields for the STA and the peer STA should be set to a same value.

### Solution 2: Using Common Information Field (Common Info Field) for Indication

An uplink length subfield (UL Length subfield) (for example, B4 to B15, with a total of 12 bits) in the common information field may be redefined as the allocation duration subfield to indicate duration allocated to the STA and the peer STA of the STA. In this case, the foregoing two (1^{st} and 2^{nd}) user information fields may no longer need to be defined as allocation duration subfields.

Method for indicating allocation of time resources to the STA and the peer STA by an MU-RTS TXS TF (corresponding to Part (IV)):

RU allocation subfields of two user information fields (User Info field) in the user information list field are used to respectively indicate an RU used by the STA and an RU used by the peer STA of the STA. It should be noted that for Part (III), RU allocation subfields for the STA (that is, 1^{st} User Info field) and the peer STA are set to a same value. For Part (IV), RU allocation subfields for the STA (that is, 1^{st} User Info field) and the peer STA are set to different values.

### 5.3 Peer STA Collection Frame (Peer STA Collect Frame)

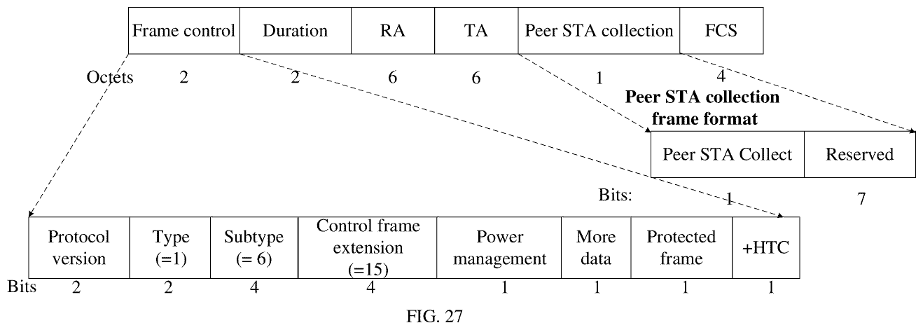

As shown in FIG. 27, a new control frame is provided, where a value 1 of a frame type (Type) indicates that the frame is a control frame, and a value 6 of a frame subtype indicates that the frame is an extended control frame. A value 14 (which may be any value from 12 to 15) of a control frame extension indicates that the frame is a control frame of a Peer STA Collect frame. This frame is used in the triggered TXOP sharing mechanism in FIG. 20 and FIG. 24. The AP sends the peer STA collection frame to inquire whether the STA has a need for P2P transmission and inquire information of the peer STA. For example, Peer STA Collect field=1 indicates that the AP inquires whether the STA has a need for P2P transmission and inquires information of the peer STA. Peer STA Collect field=0 indicates that the AP does not inquire whether the STA has a need for P2P transmission or inquire information of the peer STA.

The method in embodiments of this application has at least one of the following effects.

1. Part (I) provides a method reporting, by a STA, time resource requirements of the STA for uplink transmission and P2P transmission, to assist an AP in determining a TXOP sharing mode to be used.

2. Part (II) modifies rules for the TXOP sharing mode 2, which can save some TXOP time in a scenario in which a STA has requirements for both uplink transmission and P2P transmission.

3. Part (III) redefines rules for the AP and the peer STA to return frames to the STA. Same time resources are allocated to the peer STA and the STA through a time division method, to reduce a latency between the STA and the AP or the peer STA in the triggered TXOP sharing (triggered TXOP sharing) mechanism.

4. Part (IV) redefines rules for the AP and the peer STA to return frames to the STA. Same time resources but different frequency resources are allocated to the peer STA and the STA through a frequency division method, to reduce a latency between the STA and the AP or the peer STA in the triggered TXOP sharing mechanism.

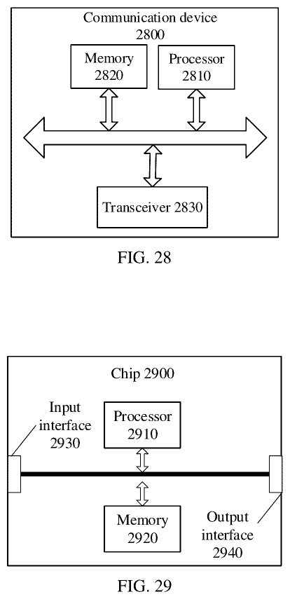

FIG. 28 is a schematic diagram of a structure of a communication device 2800 according to an embodiment of this application. The communication device 2800 includes a processor 2810, and the processor 2810 may invoke a computer program from a memory and run the computer program to cause the communication device 2800 to implement the methods in embodiments of this application.

In an implementation, the communication device 2800 may further include a memory 2820. The processor 2810 may invoke a computer program from the memory 2820 and run the computer program to cause the communication device 2800 to implement the methods in embodiments of this application.

The memory 2820 may be a separate component independent of the processor 2810, or may be integrated into the processor 2810.

In an implementation, the communication device 2800 may further include a transceiver 2830. The processor 2810 may control the transceiver 2830 to communicate with another device. Specifically, the processor 2810 may transmit information or data to the other device, or receive information or data transmitted by the other device.

The transceiver 2830 may include a transmitting set and a receiving set. The transceiver 2830 may further include an antenna, and the number of antennas may be one or more.

In an implementation, the communication device 2800 may be the second device in embodiments of this application, and the communication device 2800 may implement corresponding processes implemented by the second device in methods in embodiments of this application. For brevity, details are not described herein again.

In an implementation, the communication device 2800 may be the first device in embodiments of this application, and the communication device 2800 may implement corresponding processes implemented by the first device in methods in embodiments of this application. For brevity, details are not described herein again.

FIG. 29 is a schematic diagram of a structure of a chip 2900 according to an embodiment of this application. The chip 2900 includes a processor 2910, and the processor 2910 may invoke a computer program from a memory and run the computer program to implement the methods in embodiments of this application.

In an implementation, the chip 2900 may further include a memory 2920. The processor 2910 may invoke a computer program from the memory 2920 and run the computer program, so as to implement the method executed by the first device or the second device in embodiments of this application.

The memory 2920 may be a separate component independent of the processor 2910, or may be integrated into the processor 2910.

In an implementation, the chip 2900 may further include an input interface 2930. The processor 2910 may control the input interface 2930 to communicate with another device or chip, and specifically, may obtain information or data transmitted by the other device or chip.

In an implementation, the chip 2900 may further include an output interface 2940. The processor 2910 may control the output interface 2940 to communicate with another device or chip, and specifically, may output information or data to the other device or chip.

In an implementation, the chip may be applied to the second device in embodiments of this application, and the chip may implement corresponding processes implemented by the second device in methods in embodiments of this application. For brevity, details are not described herein again.

In an implementation, the chip may be applied to the first device in embodiments of this application, and the chip may implement corresponding processes implemented by the first device in methods in embodiments of this application. For brevity, details are not described herein again.

Chips applied to the first device and the second device may be a same chip or different chips.

It should be understood that the chip mentioned in this embodiment of this application may alternatively be referred to as a system-level chip, a system chip, a chip system, or a system-on-chip.

The foregoing mentioned processor may be a general-purpose processor, a digital signal processor (DSP), a field programmable gate array (FPGA), an application-specific integrated circuit (ASIC) or another programmable logic device, a transistor logic device, a discrete hardware component, or the like. The general-purpose processor may be a microprocessor, or may be any conventional processor or the like.

The foregoing mentioned memory may be a volatile memory or a non-volatile memory, or may include both a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random-access memory (RAM).

It should be understood that, by way of example but not limitative description, for example, the memory in the embodiment of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct rambus random access memory (Direct Rambus RAM, DR RAM), or the like. In other words, the memory in this embodiment of this application includes but is not limited to these memories and any memory of another proper type.

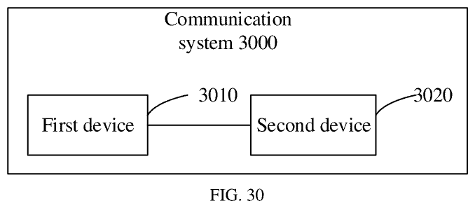

FIG. 30 is a schematic block diagram of a communication system 3000 according to an embodiment of this application. The communication system 3000 includes a first device 3010 and a second device 3020.

The first device 3010 is configured to control frame transmission within a shared TXOP time based on a TXOP sharing mode and/or a channel detection result.

The second device 3020 is configured to control frame transmission within the shared TXOP time based on the TXOP sharing mode.

The first device 3010 may be configured to implement corresponding functions implemented by the first device in the foregoing method 500, and the second device 3020 may be configured to implement corresponding functions implemented by the second device in the foregoing method 600. For brevity, details are not described herein again.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any available medium accessible by a computer or a data storage device such as a server or a data center that integrates one or more available media. The available medium may be a magnetic medium (for example, a floppy disk, a hard disk, or a magnetic tape), an optical medium (for example, a DVD), a semiconductor medium (for example, a solid-state disk (SSD)), or the like.

It should be understood that, in embodiments of this application, sequence numbers of the foregoing processes do not mean execution sequences. The execution sequences of the processes should be determined according to functions and internal logic of the processes, and should not be construed as any limitation on the implementation processes of embodiments of this application.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

The foregoing describes merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
controlling, by a first device, frame transmission within a shared TXOP time based on a transmission opportunity TXOP sharing mode and/or a channel detection result.

2. A first device, comprising:
a processor; and
a memory, wherein the memory is configured to store a computer program, and the processor is configured to invoke and run the computer program stored in the memory to cause the first device to perform:
controlling frame transmission within a shared TXOP time based on a transmission opportunity TXOP sharing mode and/or a channel detection result.

3. The first device according to claim 2, wherein the processor is configured to invoke and run the computer program stored in the memory to cause the first device to further perform:
performing channel detection to obtain the channel detection result.

4. The first device according to claim 3, wherein the performing channel detection comprises:
in a case that the TXOP sharing mode is a TXOP sharing mode 2 and a clear to send CTS frame returned by a second device is received, performing at least one of following:
using a carrier sensing mechanism to detect a channel medium within a priority interframe space PIFS time after the first device completes sending an immediate response frame to the second device; or
using a carrier sensing mechanism to detect a channel medium within a PIFS time after the first device receives a frame that is sent by the second device and that does not require an immediate response.

5. The first device according to claim 4, wherein the controlling frame transmission within a shared TXOP time based on a TXOP sharing mode and/or a channel detection result comprises:
in the case of the TXOP sharing mode 2 and in a case that the channel medium is idle, sending, by the first device, a PPDU at a first moment after the PIFS.

6. The first device according to claim 5, wherein
the first moment is after the second device completes sending all frames and before the shared TXOP time ends within the shared TXOP time.

7. The first device according to claim 2, wherein the processor is configured to invoke and run the computer program stored in the memory to cause the first device to further perform:
sending a buffer status report poll BSRP trigger frame to the second device.

8. The first device according to claim 2, wherein the processor is configured to invoke and run the computer program stored in the memory to cause the first device to further perform:
sending a peer device collection frame to the second device, wherein the peer device collection frame comprises a peer device collection field, and the peer device collection field is used to inquire whether the second device has a need for P2P transmission and/or inquire about information of a third device that is on a peer end of the second device.

9. The first device according to claim 2, wherein the processor is configured to invoke and run the computer program stored in the memory to cause the first device to further perform:
receiving a peer report frame from the second device, wherein the peer report frame is used to report information of the third device that is on the peer end and that is about to perform P2P communication with the second device.

10. The first device according to claim 9, wherein the peer report frame comprises a QoS control field, and wherein the QoS control field comprises at least one of following:
a first subfield, used to indicate that the information indicated by the QoS control field is used for a transmission type of the second device; or
a second subfield, used to indicate a length of time that the second device requests the first device to share.

11. The first device according to claim 10, wherein a value of the first subfield represents at least one of following:
the information indicated by the QoS control field is used for uplink transmission from the second device to the first device; or
the information indicated by the QoS control field is used for P2P transmission from the second device to the third device.

12. The first device according to claim 10, wherein in a case that a triggered TXOP sharing support field in an EHT capabilities element of each of the first device and the second device is 1, a QoS control field of a frame sent by the second device and received by the first device is used to indicate at least one of following:
B4 or B7 of the QoS control field is set to a first value, and B8 to B15 of the QoS control field represent a TXOP duration request used for only uplink transmission; or
B4 or B7 of the QoS control field is set to a second value, and B8 to B15 of the QoS control field represent a TXOP duration request for at least P2P transmission.

13. A second terminal, comprising:
a processor; and
a memory, wherein the memory is configured to store a computer program, and the processor is configured to invoke and run the computer program stored in the memory to cause the second device to perform:
controlling frame transmission within a shared TXOP time based on a TXOP sharing mode.

14. The second terminal according to claim 13, wherein the controlling frame transmission within a shared TXOP time based on a TXOP sharing mode comprises at least one of following:
performing, by the second device, P2P transmission and uplink transmission sequentially in a case that the TXOP sharing mode is a TXOP sharing mode 2 and there are uplink transmission and P2P transmission;
performing, by the second device, only uplink transmission in a case that the TXOP sharing mode is a TXOP sharing mode 2 and there is only uplink transmission; or
performing, by the second device, only P2P transmission in a case that the TXOP sharing mode is a TXOP sharing mode 2 and there is only P2P transmission,
wherein the uplink transmission is uplink transmission from the second device to a first device, and the P2P transmission is P2P transmission from the second device to a peer third device.

15. The second terminal according to claim 13, wherein the processor is configured to invoke and run the computer program stored in the memory to cause the second device to further perform:
receiving a BSRP trigger frame from a first device.

16. The second terminal according to claim 13, wherein the processor is configured to invoke and run the computer program stored in the memory to cause the second device to further perform:
receiving a peer device collection frame from a first device, and wherein the peer device collection frame comprises a peer device collection field, and the peer device collection field is used to inquire whether the second device has a need for P2P transmission and/or inquire about information of a third device that is on a peer end of the second device.

17. The second terminal according to claim 13, wherein the processor is configured to invoke and run the computer program stored in the memory to cause the second device to further perform:
sending a peer report frame to a first device, wherein the peer report frame is used to report information of a third device that is on the peer end and that is about to perform P2P communication with the second device.

18. The second terminal according to claim 17, wherein the peer report frame comprises a QoS control field, and the QoS control field comprises at least one of following:
a first subfield, used to indicate that information indicated by the QoS control field is used for a transmission type of the second device; or
a second subfield, used to indicate a length of time that the second device requests the first device to share.

19. The second terminal according to claim 18, wherein a value of the first subfield represents at least one of following:
the information indicated by the QoS control field is used for uplink transmission from the second device to the first device; or
the information indicated by the QoS control field is used for P2P transmission from the second device to the third device.

20. The second terminal according to claim 18, wherein in a case that a triggered TXOP sharing support field in an EHT capabilities element of each of the first device and the second device is 1, a QoS control field of a frame sent by the second device and received by the first device is used to indicate at least one of following:
B4 or B7 of the QoS control field is set to a first value, and B8 to B15 of the QoS control field represent a TXOP duration request used for only uplink transmission; or
B4 or B7 of the QoS control field is set to a second value, and B8 to B15 of the QoS control field represent a TXOP duration request for at least P2P transmission.
